(19) United States
(12) Patent Application Publication
(10) Pub. No.: US 2025/0008950 A1
(43) Pub. Date: Jan. 9, 2025

(54) BIOCIDE COMPOSITIONS

(71) Applicant: BASF SE, Ludwigshafen Am Rhein (DE)

(72) Inventors: Rodney KLIMA, Cincinnati, OH (US); Dean OESTER, Cincinnati, OH (US)

(21) Appl. No.: 18/711,649

(22) PCT Filed: Nov. 28, 2022
(86) PCT No.: PCT/EP22/83386

§ 371 Date: May 20, 2024

Related U.S. Application Data
(60) Provisional application No. 63/284,745, filed on Dec. 1, 2021.

(30) Foreign Application Priority Data
Jan. 12, 2022 (EP) 22151072.0

(51) Int. Cl. A01N 25/04; A01N 43/54; A01P 3/00

(52) U.S. Cl. CPC A01N 25/04; A01N 43/54; A01P 3/00

(57) ABSTRACT

Disclosed herein is a composition (C) including: (A) a solvent system and (B) at least one biocide. The solvent system (A) includes (A1) a first component selected from an organic keto compound (A1a), an organic amine (A1b), and a combination thereof; and (A2) a second component selected from an organic acid (A2a), an alcohol (A2b), an ester (A2c), an ether (A2d), and a combination thereof.

### FIELD OF INVENTION

The presently claimed invention is directed to a composition (C) comprising: (A) a solvent and (B) at least one biocide. The solvent system (A) comprises (A1) first component selected from an organic keto compound (A1a), an organic amine (A1b), or a combination thereof; and (A2) a second component selected from an organic acid (A2a), an alcohol (A2b), an ester (A2c), an ether (A2d), or a combination thereof.

### BACKGROUND OF INVENTION

Typically, biocides are formulated as aqueous solutions or as emulsifiable concentrates. Prior to use, the emulsifiable concentrate is then emulsified with water. A problem often encountered when emulsifying the emulsifiable concentrate is the crystallization of the biocide(s) from the emulsion. Beside the loss of active ingredient due to crystallization, crystallization of the biocide(s) also causes blocking of filters and/or nozzles when the emulsion is to be applied via spray equipment. As crystallization increases over time, it necessitates that the application of the emulsion takes place immediately or within a few hours after the emulsion is formed.

There have been numerous suggestions on how to solve this crystallization problem of the biocide(s). By example, in U.S. Pat. No. 5,206,225 A it is suggested to use certain alkylcarboxylic acid dimethylamides as crystallization inhibitors in spray solutions; U.S. Pat. No. 5,476,845 A discloses certain phosphoric esters as crystallization inhibitors; in U.S. Pat. No. 5,328,693 A, 5,369,118 A, certain long chain alkyl lactams are suggested as crystallization inhibitors; U.S. Pat. No. 5,053,421 A suggests di-styryl-phenyl-tri-glycol ether as crystallization inhibitor. There are several prior arts suggesting adding certain compounds as crystallization inhibitors.

Most biocides have very limited solubility in water or organic solvents; therefore, instead of emulsion concentrates, they have been formulated as suspension concentrates. Suspension concentrates also encounter similar problems such as crystallization of the biocide. The crystallization of the biocide(s) lead to the blocking of the filters and/or nozzles of the spray equipment during the application.

EP 933025 A1 discloses an emulsifiable concentrate formulation comprising a pesticide, a solvent system comprising esters of plant oils and a water-miscible polar aprotic cosolvent and an emulsifier system comprising a mixture of both anionic and non-ionic surfactants.

GB 2 091 558 A discloses that high amounts of biocidal organotin compounds can be dissolved in water immiscible alcohol at 50° C. and aromatic hydrocarbon solvent to give solutions which remain stable upon cooling.

EP 0095242 discloses a liquid composition of fungicides in alkylated benzene sulfonic acids. However, the solubility of the biocides is very low as 2 to 10 wt. %.

WO 2010/052178 A1 discloses another solvent system based on cyclohexanone or acetophenone. However, the solubility of the biocides in these solvent systems are either less or around 10 wt. %.

Despite the progress disclosed in the prior art there is still a need for improved emulsifiable concentrate formulations giving rise to a low degree of crystal formation or completely eliminate the crystallization in the emulsifiable concentrates or diluted ready to use emulsions. In addition, it would be desirable to replace the aromatic hydrocarbon solvent from the emulsifiable concentrate with more environment friendly solvents. Yet another objective of the presently claimed invention is to replace the suspension concentrates with an emulsifiable concentrate, as suspension concentrate pose many potential problems for producers such as need to mill the biocides into fine powder and for farmers such as higher cost, equipment clogging and limited suspension stability. Still another object of the presently claimed invention is to provide a solvent system which can dissolve higher amount of biocide, preferably at least 5 wt. %, more preferably at least 20 wt. % based on overall weight of biocide and solvent system. Another object is to provide a solvent system which is devoid of environmental hazardous aromatic hydrocarbon.

### SUMMARY OF INVENTION

Surprisingly, it has been found that biocides can be solubilized in a solvent system (A) comprising a composition (C) comprising: (A) a solvent and (B) at least one biocide. The solvent system (A) comprises (A1) a first component selected from an organic keto compound (A1a), an organic amine (A1b) or a combination thereof; and (A2) a second component selected from an organic acid (A2a), an alcohol (A2b), an ester (A2c), an ether (A2d), or a combination thereof. Such compositions can be formulated as an emulsifiable solutions which eliminates or reduces the problem associated with the low solubility of the biocides and all other disadvantages of the solid concentrates. Without being bound to this theory, when the first component (A1) and the second component (A2) are combined in a specific molar ratio they form a solution, which can dissolve the biocides. The so obtained solution can easily be emulsified and forms a stable emulsion when emulsified in water. Surprisingly, it has been found that such solutions eliminate or reduces the problem of crystallization of the biocides from the emulsifiable solutions and from the final ready to use emulsion.

Accordingly, the first aspect of the presently claimed invention is directed to a composition (C) comprising:
i) a solvent system (A) in an amount of 15.0 to 95.0% by weight, based on the overall weight of the composition; and
ii) at least one biocide (B) in an amount of 5.0 to 60.0% by weight, based on the overall weight of the composition;
   wherein the total amount of the solvent system (A) and the at least one biocide (B) is in the range of 20.0 to 100% by weight based on the overall weight of the composition, wherein the solvent system (A) comprises:
   (A1) a first component selected from an organic keto compound (A1a), an organic amine (A1b), or a combination thereof; and
   (A2) a second component selected from an organic acid (A2a), an alcohol (A2b), an ester (A2c), an ether (A2d), or a combination thereof;
wherein Hansen solubility parameters of the first component are in the ranges of δ d 13-20 MPa^{1/2}, δ p 0.2-23 MPa^{1/2} and δ h 1-24 MPa^{1/2} and Hansen solubility parameters of the second component are in the ranges of δ d 13-25 MPa^{1/2}, δ p 1-15 MPa^{1/2}, and δ h 2-30 MPa^{1/2},
   wherein the mole ratio of total amount of A1 to the total amount of A2 is in the range of 1.0:5.0 to 5.0:1.0.

The second aspect of the presently claimed invention is directed to the use of a solvent system (A) for preparing an emulsifiable concentrate comprising at least one biocide (B), wherein the solvent system (A) comprises:
(A1) a first component selected from an organic keto compound (A1a), an organic amine (A1b) or a combination thereof; and
(A2) a second component selected from an organic acid (A2a), an alcohol (A2b), an ester (A2c), an ether (A2d), or a combination thereof;
wherein Hansen solubility parameters of the first component are in the ranges of δ d 13-20 MPa^{1/2}, δ p 0.2-23 MPa^{1/2} and δ h 1-24 MPa^{1/2} and the Hansen solubility parameters of the second component (A2) are in the ranges of δ d 13-25 MPa^{1/2}, δ p 1-15 MPa^{1/2}, and δ h 2-30 MPa^{1/2}, wherein the mole ratio of total amount of A1 to the total amount of A2 is in the range of 1.0:5.0 to 5.0:1.0.

The third aspect of the presently claimed invention is directed to a method of preparing a composition (C) comprising the steps of:
(i) providing a solvent system (A); and
(ii) adding at least one biocide (B) to the solvent system (A) of step i. to obtain a mixture;
   wherein the solvent system (A) comprises:
   (A1) a first component selected from an organic keto compound (A1a), an organic amine (A1b) or a combination thereof; and
   (A2) a second component selected from an organic acid (A2a), an alcohol (A2b), an ester (A2c), an ether (A2d), or a combination thereof;
   wherein Hansen solubility parameters of the first component are in the ranges of δ d 13-20 MPa^{1/2}, δ p 0.2-23 MPa^{1/2} and δ h 1-24 MPa^{1/2} and the Hansen solubility parameters of the second component (A2) are in the ranges of δ d 13-25 MPa^{1/2}, δ p 1-15 MPa^{1/2}, and δ h 2-30 MPa^{1/2},
   wherein the mole ratio of total amount of A1 to the total amount of A2 is in the range of 1.0:5.0 to 5.0:1.0

The fourth aspect of the presently claimed invention is directed to an emulsion composition (E) comprising:
(a) composition (C) according to first aspect in an amount in the range of 0.1 to 20.0% by weight, based on the overall weight of the emulsion composition (E); and
(b) water in an amount in the range of 60.0 to 99.9% by weight based on the overall weight of the composition (E);
   wherein the total amount of the composition (C) and water is in the range of 61.1 to 100% by weight based on the overall weight of the emulsion composition (E).

The fifth aspect of the presently claimed invention is directed to a process for preparing an emulsion composition (E) according to fourth aspect comprising the steps of:
(i) providing a composition (C) according to first aspect; and
(ii) adding water to the composition (C) of step (i) to obtain an emulsion composition (E).

The sixth aspect of the presently claimed invention is directed to the use of the emulsion composition (E) for the treatment of soil and plants.

The seventh aspect of the presently claimed invention is directed to a method of treating soil and plants comprising the step of applying the emulsion composition (E) to the soil or plants.

### DETAILED DESCRIPTION

Before the present compositions and formulations of the presently claimed invention are described, it is to be understood that this invention is not limited to particular compositions and formulations described, since such compositions and formulation may, of course, vary. It is also to be understood that the terminology used herein is not intended to be limiting, since the scope of the presently claimed invention will be limited only by the appended claims.

If hereinafter a group is defined to comprise at least a certain number of embodiments, this is meant to also encompass a group which preferably consists of these embodiments only. Furthermore, the terms ‘first’, ‘second’, ‘third’ or ‘a’, ‘b’, ‘c’, etc. and the like in the description and in the claims, are used for distinguishing between similar elements and not necessarily for describing a sequential or chronological order.

It is to be understood that the terms so used are interchangeable under appropriate circumstances and that the embodiments of the presently claimed invention described herein are capable of operation in other sequences than described or illustrated herein. In case the terms ‘first’, ‘second’, ‘third’ or ‘(A)’, ‘(B)‘ and’(C)‘ or’(a)’, ‘(b)’, ‘(c)’, ‘(d)’, ‘i’, ‘ii’ etc. relate to steps of a method or use or assay there is no time or time interval coherence between the steps, that is, the steps may be carried out simultaneously or there may be time intervals of seconds, minutes, hours, days, weeks, months or even years between such steps, unless otherwise indicated in the application as set forth herein above or below.

Furthermore, the ranges defined throughout the specification include the end values as well i.e. a range of 1 to 10 implies that both 1 and 10 are included in the range. For the avoidance of doubt, applicant shall be entitled to any equivalents according to applicable law.

In the following passages, different aspects of the presently claimed invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to ‘one embodiment’ or ‘an embodiment’ means that a particular feature, structure or characteristic described in connection with the embodiment is included in at least one embodiment of the presently claimed invention. Thus, appearances of the phrases ‘in one embodiment’ or ‘in an embodiment’ in various places throughout this specification are not necessarily all referring to the same embodiment.

Furthermore, the particular features, structures or characteristics may be combined in any suitable manner, as would be apparent to a person skilled in the art from this disclosure, in one or more embodiments. Furthermore, while some embodiments described herein include some, but not other features included in other embodiments, combination of features of different embodiments are meant to be within the scope of the presently claimed invention, and form different embodiments, as would be understood by those in the art. For example, in the appended claims, any of the claimed embodiments can be used in any combination.

Within the context of the presently claimed invention, the Hansen solubility parameters for the solvents has been calculated at 25° C. and at atmospheric pressure unless otherwise specified. Hansen Solubility Parameters: a user's handbook by Charles M Hansen is a standard reference guide.

Within the context of the presently claimed invention, if a solvent has two functional groups the compound is grouped into a solvent based on the priority of the functional group as per IUPAC nomenclature. For example, monoalkyl esters of a diacid is grouped as acid solvent system (A) for the presently claimed invention.

In a first embodiment, the presently claimed invention is directed to a composition (C) comprising:
i) a solvent system (A) in an amount of 15.0 to 95.0% by weight, based on the overall weight of the composition; and
ii) at least one biocide (B) in an amount of 5.0 to 60.0% by weight, based on the overall weight of the composition;
   wherein the total amount of the solvent system (A) and the at least one biocide (B) is in the range of 20.0 to 100% by weight based on the overall weight of the composition,
   wherein the solvent system (A) comprises:
   (A1) a first component selected from an organic keto compound (A1a), an organic amine (A1b) or a combination thereof; and
   (A2) a second component selected from an organic acid (A2a), an alcohol (A2b), an ester (A2c), an ether (A2d), or a combination thereof;
   wherein Hansen solubility parameters of the first component are in the ranges of δ d 13-20 MPa^{1/2}, δ p 0.2-23 MPa^{1/2} and δ h 1-24 MPa^{1/2} and Hansen solubility parameters of the second component are in the ranges of δ d 13-25 MPa^{1/2}, δ p 1-15 MPa^{1/2}, and δ h 2-30 MPa^{1/2},
   wherein the mole ratio of total amount of A1 to the total amount of A2 is in the range of 1.0:5.0 to 5.0:1.0;
   preferably the composition (C) comprises:
i) a solvent system (A) in an amount of 25.0 to 85.0% by weight, based on the overall weight of the composition; and
ii) at least one biocide (B) in an amount of 10.0 to 50.0% by weight, based on the overall weight of the composition;
   wherein the total amount of the solvent system (A) and the at least one biocide (B) is in the range of 35.0 to 100% by weight based on the overall weight of the composition,
   wherein the solvent system (A) comprises:
   (A1) a first component selected from an organic keto compound (A1a), an organic amine (A1b) or a combination thereof; and
   (A2) a second component selected from an organic acid (A2a), an alcohol (A2b), an ester (A2c), an ether (A2d), or a combination thereof;
   wherein Hansen solubility parameters of the first component are in the ranges of δ d 13-20 MPa^{1/2}, δ p 0.2-23 MPa^{1/2} and δ h 1-24 MPa^{1/2} and Hansen solubility parameters of the second component are in the ranges of δ d 13-25 MPa^{1/2}, δ p 1-15 MPa^{1/2}, and δ h 2-30 MPa^{1/2},
   wherein the mole ratio of total amount of A1 to the total amount of A2 is in the range of 1.0:5.0 to 5.0:1.0;
   more preferably the composition (C) comprises:
i) a solvent system (A) in an amount of 40.0 to 85.0% by weight, based on the overall weight of the composition; and
ii) at least one biocide (B) in an amount of 15.0 to 50.0% by weight, based on the overall weight of;
   wherein the total amount of the solvent system (A) and the at least one biocide (B) is in the range of 55.0 to 100% by weight based on the overall weight of the composition,
   wherein the solvent system (A) comprises:
   (A1) a first component selected from an organic keto compound (A1a), an organic amine (A1b) or a combination thereof; and
   (A2) a second component selected from an organic acid (A2a), an alcohol (A2b), an ester (A2c), an ether (A2d), or a combination thereof;
   wherein Hansen solubility parameters of the first component are in the ranges of δ d 13-20 MPa^{1/2}, δ p 0.2-23 MPa^{1/2} and δ h 1-24 MPa^{1/2} and Hansen solubility parameters of the second component are in the ranges of δ d 13-25 MPa^{1/2}, δ p 1-15 MPa^{1/2}, and δ h 2-30 MPa^{1/2},
   wherein the mole ratio of total amount of A1 to the total amount of A2 is in the range of 1.0:5.0 to 5.0:1.0;
most preferably the composition (C) comprises:
i) a solvent system (A) in an amount of 40.0 to 80.0% by weight, based on the overall weight of the composition; and
ii) at least one biocide (B) in an amount of 15.0 to 50.0% by weight, based on the overall weight of the composition;
   wherein the total amount of the solvent system (A) and the at least one biocide (B) is in the range of 55.0 to 100% by weight based on the overall weight of the composition, wherein the solvent system (A) comprises:
   (A1) a first component selected from an organic keto compound (A1a), an organic amine (A1b) or a combination thereof; and
   (A2) a second component selected from an organic acid (A2a), an alcohol (A2b), an ester (A2c), an ether (A2d), or a combination thereof;
   wherein Hansen solubility parameters of the first component are in the ranges of δ d 13-20 MPa^{1/2}, δ p 0.2-23 MPa^{1/2} and δ h 1-24 MPa^{1/2} and Hansen solubility parameters of the second component are in the ranges of δ d 13-25 MPa^{1/2}, δ p 1-15 MPa^{1/2}, and δ h 2-30 MPa^{1/2},
   wherein the mole ratio of total amount of A1 to the total amount of A2 is in the range of 1.0:5.0 to 5.0:1.0; and
   in particular preferably the composition (C) comprises:
i) a solvent system (A) in an amount of 50.0 to 80.0% by weight, based on the overall weight of the composition; and
ii) at least one biocide (B) in an amount of 20.0 to 50.0% by weight, based on the overall weight of the composition;
   wherein the total amount of the solvent system (A) and at least one biocide (B) is in the range of 70.0 to 100% by weight based on the overall weight of the composition,
   wherein the solvent system comprises:
   (A1) a first component selected from an organic keto compound (A1a), an organic amine (A1b) or a combination thereof; and
   (A2) a second component selected from an organic acid (A2a), an alcohol (A2b), an ester (A2c), an ether (A2d), or a combination thereof;
   wherein Hansen solubility parameters of the first component are in the ranges of δ d 13-20 MPa^{1/2}, δ p 0.2-23 MPa^{1/2} and δ h 1-24 MPa^{1/2} and Hansen solubility parameters of the second component are in the ranges of δ d 13-25 MPa^{1/2}, δ p 1-15 MPa^{1/2}, and δ h 2-30 MPa^{1/2},
   wherein the mole ratio of total amount of A1 to the total amount of A2 is in the range of 1.0:5.0 to 5.0:1.0.

In an embodiment, the presently claimed invention is directed to a composition (C) comprising:
i) a solvent system (A) in an amount of 15.0 to 95.0% by weight, preferably 25.0 to 85.0% by weight, more preferably 40.0 to 85.0% by weight, most preferably 40.0 to 80.0% by weight, in particular 50.0 to 80.0% by weight based on the overall weight of the composition; and
ii) at least one biocide (B) in an amount of 5.0 to 60.0% by weight, preferably 10.0 to 50.0% by weight, more preferably 15.0 to 50.0% by weight, most preferably 15.0 to 50.0% by weight, in particular 20.0 to 50.0% by weight based on the overall weight of the composition;
   wherein the total amount of the solvent system (A) and the at least one biocide (B) is in the range of 20.0 to 100% by weight, preferably 35.0 to 100% by weight, more preferably 55.0 to 100% by weight, most preferably 70.0 to 100% by weight based on the overall weight of the composition,
   wherein the solvent system (A) comprises:
   (A1) a first component, an organic keto compound (A1a); and
   (A2) a second component selected from an organic acid (A2a), an alcohol (A2b), an ester (A2c), an ether (A2d), or a combination thereof;
   wherein Hansen solubility parameters of the first component are in the ranges of δ d 13-20 MPa^{1/2}, δ p 0.2-23 MPa^{1/2} and δ h 1-24 MPa^{1/2} and Hansen solubility parameters of the second component are in the ranges of δ d 13-25 MPa^{1/2}, δ p 1-15 MPa^{1/2}, and δ h 2-30 MPa^{1/2},
   wherein the mole ratio of total amount of A1 to the total amount of A2 is in the range of 1.0:5.0 to 5.0:1.0, preferably 1.0:3.0 to 3.0:1.0, more preferably 1.0:2.0 to 2.0:1.0.

In the above embodiment, the organic keto compound (A1a) is selected from acetophenone, benzophenone, n-butyl acetoacetate, cyclohexanone, methyl cyclohexanone, cyclodecanone, cycloheptanone, cyclooctaone, cyclopropylmethyl ketone, diethyl ketone, di-isobutyl ketone, dimethyldiketone, dipropylketone, ethyl butyl ketone, isophorone, pentoxone, methyl butyl ketone, methyl ethyl ketone, methyl isoamyl ketone, methyl isobutyl ketone, methyl isopropenyl ketone, methyl n-amyl ketone, or methyl n-propyl ketone, preferably, acetophenone, benzophenone, cyclohexanone, ethyl butyl ketone or methyl n-propyl ketone.

In an embodiment, the presently claimed invention is directed to a composition (C) comprising:
i) a solvent system (A) in an amount of 15.0 to 95.0% by weight, preferably 25.0 to 85.0% by weight, more preferably 40.0 to 85.0% by weight, most preferably 40.0 to 80.0% by weight, in particular 50.0 to 80.0% by weight based on the overall weight of the composition; and
ii) at least one biocide (B) in an amount of 5.0 to 60.0% by weight, preferably 10.0 to 50.0% by weight, more preferably 15.0 to 50.0% by weight, most preferably 15.0 to 50.0% by weight, in particular 20.0 to 50.0% by weights based on the overall weight of the composition;
   wherein the total amount of the solvent system (A) and the at least one biocide (B) is in the range of 20.0 to 100% by weight preferably 35.0 to 100% by weight, more preferably 55.0 to 100% by weight, most preferably 70.0 to 100% by weight based on the overall weight of the composition,
   wherein the solvent system (A) comprises:
   (A1) a first component, an organic amine (A1b); and
   (A2) a second component selected from an organic acid (A2a), an alcohol (A2b), an ester (A2c), an ether (A2d), or a combination thereof;
   wherein Hansen solubility parameters of the first component are in the ranges of δ d 13-20 MPa^{1/2}, δ p 0.2-23 MPa^{1/2} and δ h 1-24 MPa^{1/2} and Hansen solubility parameters of the second component are in the ranges of δ d 13-25 MPa^{1/2}, δ p 1-15 MPa^{1/2}, and δ h 2-30 MPa^{1/2},
   wherein the mole ratio of total amount of A1 to the total amount of A2 is in the range of 1.0:5.0 to 5.0:1.0, preferably 1.0:3.0 to 3.0:1.0, more preferably 1.0:2.0 to 2.0:1.0.

In the above embodiment, the organic amine compound (A1b) aniline, methoxy aniline, n-butyl amine, cyclohexylamine, di-2-ethylhexlamine, diethanolamine, di-isobutyl amine, ethylenediamine, N-formyl hexamethyleneimine, isopropyl amine, methylamine, propyl amine, pyridine, quinoline or triethylamine.

In another preferred embodiment, the presently claimed invention is directed to a composition (C) comprising:
i) a solvent system (A) in an amount of 15.0 to 94.0% by weight, based on the overall weight of the composition;
ii) at least one biocide (B) in an amount of 5.0 to 60.0% by weight, based on the overall weight of the composition; and
iii) at least one emulsifier (D) in an amount of 1.0 to 50.0% by weight, based on the overall weight of the composition (C)
   wherein the total amount of the solvent system (A), the at least one biocide (B) and the at least one emulsifier (D) is in the range of 21.0 to 100% by weight based on the overall weight of the composition,
   wherein the solvent system (A) comprises:
   (A1) a first component selected from an organic keto compound (A1a), an organic amine (A1b) or a combination thereof; and
   (A2) a second component selected from an organic acid (A2a), an alcohol (A2b), an ester (A2c), an ether (A2d), or a combination thereof;
   wherein Hansen solubility parameters of the first component are in the ranges of δ d 13-20 MPa^{1/2}, δ p 0.2-23 MPa^{1/2} and δ h 1-24 MPa^{1/2} and Hansen solubility parameters of the second component are in the ranges of δ d 13-25 MPa^{1/2}, δ p 1-15 MPa^{1/2}, and δ h 2-30 MPa^{1/2},
   wherein the mole ratio of total amount of A1 to the total amount of A2 is in the range of 1.0:5.0 to 5.0:1.0;
   more preferably the composition (C) comprises:
i) a solvent system (A) in an amount of 25.0 to 85.0% by weight, based on the overall weight of the composition;
ii) at least one biocide (B) in an amount of 10.0 to 50.0% by weight, based on the overall weight of the composition; and
iii) at least one emulsifier (D) in an amount of 1.0 to 40.0% by weight, based on the overall weight of the composition (C)
   wherein the total amount of the solvent system (A), the at least one biocide (B) and the at least one emulsifier (D) is in the range of 36.0 to 100% by weight based on the overall weight of the composition,
   wherein the solvent system (A) comprises:
   (A1) a first component selected from an organic keto compound (A1a), an organic amine (A1b) or a combination thereof; and
   (A2) a second component selected from an organic acid (A2a), an alcohol (A2b), an ester (A2c), an ether (A2d), or a combination thereof;
   wherein Hansen solubility parameters of the first component are in the ranges of δ d 13-20 MPa^{1/2}, δ p 0.2-23 MPa^{1/2} and δ h 1-24 MPa^{1/2} and Hansen solubility parameters of the second component are in the ranges of δ d 13-25 MPa^{1/2}, δ p 1-15 MPa^{1/2}, and δ h 2-30 MPa^{1/2},
   wherein the mole ratio of total amount of A1 to the total amount of A2 is in the range of 1.0:5.0 to 5.0:1.0;
even more preferably the composition (C) comprises:
i) a solvent system (A) in an amount of 40.0 to 80.0% by weight, based on the overall weight of the composition;
ii) at least one biocide (B) in an amount of 15.0 to 50.0% by weight, based on the overall weight of the composition; and
iii) at least one emulsifier (D) in an amount of 5.0 to 30.0% by weight, based on the overall weight of the composition (C)
   wherein the total amount of the solvent system (A), the at least one biocide (B) and the at least one emulsifier (D) is in the range of 55.0 to 100% by weight based on the overall weight of the composition,
   wherein the solvent system (A) comprises:
   (A1) a first component selected from an organic keto compound (A1a), an organic amine (A1b) or a combination thereof; and
   (A2) a second component selected from an organic acid (A2a), an alcohol (A2b), an ester (A2c), an ether (A2d), or a combination thereof;
   wherein Hansen solubility parameters of the first component are in the ranges of δ d 13-20 MPa^{1/2}, δ p 0.2-23 MPa^{1/2} and δ h 1-24 MPa^{1/2} and Hansen solubility parameters of the second component are in the ranges of δ d 13-25 MPa^{1/2}, δ p 1-15 MPa^{1/2}, and δ h 2-30 MPa^{1/2},
   wherein the mole ratio of total amount of A1 to the total amount of A2 is in the range of 1.0:5.0 to 5.0:1.0;
   most preferably the composition (C) comprises:
i) a solvent system (A) in an amount of 40.0 to 80.0% by weight, based on the overall weight of the composition;
ii) at least one biocide (B) in an amount of 15.0 to 50.0% by weight, based on the overall weight of the composition; and
iii) at least one emulsifier (D) in an amount of 5.0 to 25.0% by weight, based on the overall weight of the composition (C)
   wherein the total amount of the solvent system (A), the at least one biocide (B) and the at least one emulsifier (D) is in the range of 65.0 to 100% by weight based on the overall weight of the composition,
   wherein the solvent system (A) comprises:
   (A1) a first component selected from an organic keto compound (A1a), an organic amine (A1b) or a combination thereof; and
   (A2) a second component selected from an organic acid (A2a), an alcohol (A2b), an ester (A2c), an ether (A2d), or a combination thereof;
   wherein Hansen solubility parameters of the first component are in the ranges of δ d 13-20 MPa^{1/2}, δ p 0.2-23 MPa^{1/2} and δ h 1-24 MPa^{1/2} and Hansen solubility parameters of the second component are in the ranges of δ d 13-25 MPa^{1/2}, δ p 1-15 MPa^{1/2}, and δ h 2-30 MPa^{1/2},
   wherein the mole ratio of total amount of A1 to the total amount of A2 is in the range of 1.0:5.0 to 5.0:1.0; and
   in particular preferably the composition (C) comprises:
i) a solvent system (A) in an amount of 45.0 to 75.0% by weight, based on the overall weight of the composition;
ii) at least one biocide (B) in an amount of 20.0 to 50.0% by weight, based on the overall weight of the composition; and
iii) at least one emulsifier (D) in an amount of 5.0 to 20.0% by weight, based on the overall weight of the composition (C)
   wherein the total amount of the solvent system (A), the at least one biocide (B) and the at least one emulsifier (D) is in the range of 80.0 to 100% by weight based on the overall weight of the composition,
   wherein the solvent system (A) comprises:
   (A1) a first component selected from an organic keto compound (A1a), an organic amine (A1b) or a combination thereof; and
   (A2) a second component selected from an organic acid (A2a), an alcohol (A2b), an ester (A2c), an ether (A2d), or a combination thereof;
   wherein Hansen solubility parameters of the first component are in the ranges of δ d 13-20 MPa^{1/2}, δ p 0.2-23 MPa^{1/2} and δ h 1-24 MPa^{1/2} and Hansen solubility parameters of the second component are in the ranges of δ d 13-25 MPa^{1/2}, δ p 1-15 MPa^{1/2}, and δ h 2-30 MPa^{1/2},
   wherein the mole ratio of total amount of A1 to the total amount of A2 is in the range of 1.0:5.0 to 5.0:1.0.

In another preferred embodiment, the presently claimed invention is directed to a composition (C) comprising:
i) a solvent system (A) in an amount of 15.0 to 94.0% by weight, preferably 25.0 to 85.0% by weight, more preferably 40.0 to 80.0% by weight, in particular 45.0 to 75.0% by weight based on the overall weight of the composition;
ii) at least one biocide (B) in an amount of 5.0 to 60.0% by weight, preferably 10.0 to 50.0% by weight, more preferably 15.0 to 50.0% by weight, most preferably 20.0 to 50.0% by weight based on the overall weight of the composition; and
iii) at least one emulsifier (D) in an amount of 1.0 to 50.0% by weight, preferably 1.0 to 40.0% by weight, more preferably 5.0 to 30.0% by weight, most preferably 5.0 to 25.0% by weight, in particular 5.0 to 20.0% by weight based on the overall weight of the composition (C)
   wherein the total amount of the solvent system (A), the at least one biocide (B) and the at least one emulsifier (D) is in the range of 21.0 to 100% by weight, preferably 36.0 to 100% by weight, more preferably 55.0 to 100% by weight, most preferably 65.0 to 100% by weight, in particular 80.0 to 100% by weight based on the overall weight of the composition,
   wherein the solvent system (A) comprises:
   (A1) a first component, an organic keto compound (A1a); and
   (A2) a second component selected from an organic acid (A2a), an alcohol (A2b), an ester (A2c), an ether (A2d), or a combination thereof;
   wherein Hansen solubility parameters of the first component are in the ranges of δ d 13-20 MPa^{1/2}, δ p 0.2-23 MPa^{1/2} and δ h 1-24 MPa^{1/2} and Hansen solubility parameters of the second component are in the ranges of δ d 13-25 MPa^{1/2}, δ p 1-15 MPa^{1/2}, and δ h 2-30 MPa %,
   wherein the mole ratio of total amount of A1 to the total amount of A2 is in the range of 1.0:5.0 to 5.0:1.0, preferably 1.0:3.0 to 3.0:1.0, more preferably 1.0:2.0 to 2.0:1.0.

In the above embodiment, the organic keto compound (A1a) is selected from acetophenone, benzophenone, n-butyl acetoacetate, cyclohexanone, methyl cyclohexanone, cyclodecanone, cycloheptanone, cyclooctaone, cyclopropylmethyl ketone, diethyl ketone, di-isobutyl ketone, dimethyldiketone, dipropylketone, ethyl butyl ketone, isophorone, pentoxone, methyl butyl ketone, methyl ethyl ketone, methyl isoamyl ketone, methyl isobutyl ketone, methyl isopropenyl ketone, methyl n-amyl ketone, or methyl n-propyl ketone, preferably, acetophenone, benzophenone, cyclohexanone, ethyl butyl ketone or methyl n-propyl ketone.

In another preferred embodiment, the presently claimed invention is directed to a composition (C) comprising:
i) a solvent system (A) in an amount of 15.0 to 94.0% by weight, preferably 25.0 to 85.0% by weight, more preferably 40.0 to 80.0% by weight, in particular 45.0 to 75.0% by weight based on the overall weight of the composition;
ii) at least one biocide (B) in an amount of 5.0 to 60.0% by weight, preferably 10.0 to 50.0% by weight, more preferably 15.0 to 50.0% by weight, most preferably 20.0 to 50.0% by weight based on the overall weight of the composition; and
iii) at least one emulsifier (D) in an amount of 1.0 to 50.0% by weight, preferably 1.0 to 40.0% by weight, more preferably 5.0 to 30.0% by weight, most preferably 5.0 to 25.0% by weight, in particular 5.0 to 20.0% by weight based on the overall weight of the composition (C)
   wherein the total amount of the solvent system (A), the at least one biocide (B) and the at least one emulsifier (D) is in the range of 21.0 to 100% by weight, preferably 36.0 to 100% by weight, more preferably 55.0 to 100% by weight, most preferably 65.0 to 100% by weight, in particular 80.0 to 100% by weight based on the overall weight of the composition,
   wherein the solvent system (A) comprises:
   (A1) a first component, an organic amine (A1b); and
   (A2) a second component selected from an organic acid (A2a), an alcohol (A2b), an ester (A2c), an ether (A2d), or a combination thereof;
   wherein Hansen solubility parameters of the first component are in the ranges of δ d 13-20 MPa^{1/2}, δ p 0.2-23 MPa^{1/2} and δ h 1-24 MPa^{1/2} and Hansen solubility parameters of the second component are in the ranges of δ d 13-25 MPa^{1/2}, δ p 1-15 MPa^{1/2}, and δ h 2-30 MPa^{1/2},
   wherein the mole ratio of total amount of A1 to the total amount of A2 is in the range of 1.0:5.0 to 5.0:1.0, preferably 1.0:3.0 to 3.0:1.0, more preferably 1.0:2.0 to 2.0:1.0.

In the above embodiment, the organic amine compound (A1b) aniline, methoxy aniline, n-butyl amine, cyclohexylamine, di-2-ethylhexlamine, diethanolamine, di-isobutyl amine, ethylenediamine, N-formyl hexamethyleneimine, isopropyl amine, methylamine, propyl amine, pyridine, quinoline or triethylamine.

In another preferred embodiment, the Hansen solubility parameters of component (A1) are different from the Hansen solubility parameters of component (A2).

In an embodiment, the total amount of the first component (A1) and the second component (A2) is in the range of 60.0 to 100% by weight based on the overall weight of the solvent system; more preferably the total amount of the first component (A1) and the second component (A2) is in the range of 60.0 to 90.0% by weight based on the overall weight of the solvent system; and most preferably the total amount of the first component (A1) and the second component (A2) is in the range of 60.0 to 75.0% by weight based on the overall weight of the solvent system.

In another preferred embodiment, the biocide (B) is selected from fungicide, insecticide, acaricide, rodenticide, nematicide, herbicide, or miticide.

In another preferred embodiment, the fungicide is selected from bitertanol, bromuconazole, cyproconazole, diclobutrazole, diniconazole, epoxiconazole, etaconazole, fenbuconazole, fluquinconazole, flusilazole, flutriafol, hexaconazole, myclobutanil, penconazole, propiconazole, prothioconazole, tebuconazole, tetraconazole, triadimefon, triadimenol, triticonazole,2-aminobutane, 8-hydroxyquinoline sulphate, 2-phenylphenol (OPP), aldi-morph, ampropylfos, anilazine, azoxystrobin, benalaxyl, benodanil, benomyl, binapacryl, biphenyl, blasticidin-S, bupirimate, buthiobate, calcium polysulphide, captafol, captan, carbendazim, carboxin, carpropamid, quinomethionate, chloroneb, chloropicrin, chlorothalonil, chlozolinate, cufraneb, cyazofamid, cymoxanil, cyprodinil, cyprofuram, dichlorophen, diclocymet, diclofluanid, diclomezin, dicloran, diethofencarb, diflumetorim, dimethirimol, dimethomorph, dinocap, diphenylamine, dipyrithion, ditalimfos, dithianon, dodine, drazoxolon, edifenphos, enestroburin, ethaboxam, ethirimol, etridiazole, famoxadone, fenamidone, fenarimol, fenfuram, fenhexamid, fenitropan, fenpiclonil, fenpropidin, fenpropimorph, fentin acetate, fentin hydroxide, ferbam, ferimzone, fluazinam, fludioxonil, flumorph, fluoromide, fluoxastrobin, flusulfamide, flutolanil, folpet, fosetyl-aluminium, fphthalide, fuberidazole, furalaxyl, furmecyclox, guazatine, hexachlorobenzene, imazalil, iminoctadine, iprobenfos (IBP), iprodione, iprovalicarb, isoprothiolane, kasugamycin, copper preparations such as: copper hydroxide, copper naphthenate, copperoxychloride, copper sulphate, copper oxide, oxine-copper and Bordeaux mixture, mancopper, mancozeb, maneb, mepanipyrim, kresoxim-methyl, mepronil, metalaxyl, methasulfocarb, methfuroxam, metiram, metominostrobin, metrafenone, metsulfovax, myclobutanil, nickel dimethyldithiocarbamate, nitrothal-isopropyl, nuarimol, ofurace, oxadixyl, oxamocarb, oxycarboxin, pefurazoate, pencyuron, phosdiphen, picoxystrobin, pimaricin, piperalin, polyoxin, probenazole, prochloraz, procymidone, propamocarb, propineb, pyraclostrobin, pyrazophos, pyrifenox, pyrimethanil, pyroquilon, quinoxyfen, quintozene (PCNB), silthiofam, spiroxamine, sulphur and sulphur preparations, tecloftalam, tecnazene, thiabendazole, thicyofen, thifluzamide, thiophanate-methyl, thiram, tolclophos-methyl, tolylfluanid, triazoxide, trichlamide, tricyclazole, tridemorph, trifloxystrobin, triflumizole, triforine, validamycin, vinclozolin, zineb, ziram, or zoxamide.

In another preferred embodiment, the insecticide is selected from fenoxycarb, piperonyl butoxide, imidacloprid, thiacloprid, acetamiprid, aldicarb sulfone, pirimicarb, chlorantraniliprole, terbufos, quinalphos, dyfonate, phosmet, carbaryl, etoxazole, thiamethoxam, flonicamid, etofenprox, phorate, profenofos, parathion, methylparathion, axephate, disulfoton, fenthion, fipronil, baygon, methomyl, pymetrozine, oxamyl, fau-fluvalinate, cypermethrin, cyfluthrin, bifenthrin, tetramethrin, prallethrin (mix of isomers), permethrin (mix of isomers), resmethrin (mix of isomers), pyrethrin (mix of isomers), spinetoram (J), abamectin (mix of isomers), fenobucarb (BPMC), methiocarb, isoprocarb (MIPC), spirotetramat, Spinosad, trichlorfon, fenamiphos sulfoxide, fenamiphos sulfone, 3-hydroxycarbofuran, aldrin, DDE (p-p′), DDD (o-p), DDD (p-p′), DDE (o-p), DDT (o-p′), dieldrin, endrin, endrin aldehyde, endrin ketone, isodrin, chlordecone, or mirex(Dodecachlorooctahydro-1H-1,3,4-(epimethanetriyl)cyclobuta[cd]pentalene).

In another preferred embodiment, the acaricide is selected from tebufenpyrad, aldicard, azinphosmethyl, carbophenothion, dimethoate, dicrotophos, triazophos, malathion, phosalone, methidathion, hexythiazox, propargite, spirodiclofen, methamidophos, monocrotophos, phenthoate, pirimiphosmethyl, epn, dichlorvos, ethion, fenitrothion, diazinon, chlorpyriphos, oxydemeton methyl, pyridaben, fenpropathrin, bifenazate, spiromesifen, fenpyroximate (mix of isomers), acequinocyl, or carbofuran.

In another preferred embodiment, the rodenticide is coumaphos.

In another preferred embodiment, the nematicide is ethoprophos.

In another preferred embodiment, the herbicide is selected from paclobutrazol, diuron, linuron, isoproturon, alachlor, pendimethalin, chlorpropham, fenoprop, bentazone, metolachlor, propazine, bromacil, 2,4-DB, fenoxaprop, fluometuron, molinate, cyanazine, simazine, atrazine, atrazine desmethyl, or metribuzin.

In another preferred embodiment, the miticide is clofentezine.

In an embodiment, the biocides are selected from trifloxystrobin, boscalid, fenoxycarb, piperonyl butoxide, tebufenpyrad, iprodione, imidacloprid, imazalil, aldicarb, aldicarb sulfoxide, thiacloprid, azoxystrobin, acetamiprid, aldicarb sulfone, pirimicarb, chlorantraniliprole, azinphos-methyl, carbophenothion, coumaphos, ethoprophos, dimethoate, dicrotophosterbufos, quinalphos, triazophos, dyfonate, malathion, phosmet, phosalone, methidathion, hexythiazox, propargite, carbaryl, myclobutanil, dimethomorph, etoxazole, spirodiclofen, thiamethoxam, flonicamid, etofenprox, phorate, methamidophos, profenofos, monocrotophos, phenthoate, pirimiphosmethyl, epn, dichlorvos, edifenphos, ethion, fenitrothion, parathion, methyl parathion, acephate, disulfoton, fenthion, diazinon, chlorpyriphos, fipronil, fludioxonil, chlorothalonil, baygon, metalaxyl, methomyl, pymetrozine, pyraclostrobin, oxamyl, paclobutrazol, prochloraz, clofentezine, diuron, linuron, isoproturon, pencycuron, oxydemetonmethyl, fenvalerete, pyridaben, tau-fluvalinate, quinoxyfen, alachlor, pendimethalin, kresoximmethyl, chlorpropham, epoxiconazole, fenpropathrin, fenoprop, bentazone, metolachlor, quintozene, captan, cypermethrin, cyfluthrin, bifenthrin, tetramethrin, prallethrin (mix of isomers), permethrin (mix of isomers), resmethrin (mix of isomers), pyrethrin (mix of isomers), hexaconazole, propiconazole, bifenazate, spiromesifen, spinetoram (J), abamectin (mix of isomers), fenobucarb (BPMC), methiocarb, propazine, isoprocarb (MIPC), spirotetramat, fenpyroximate (mix of isomers), spinosad (as Spinosyn A), bromacil, 2,4-DB, fenoxaprop, fluometuron, fenhexamid, trichlorfon, fenamiphossulfoxide, fenamiphossulfone, molinate, 3-hydroxycarbofuran, thiophanatemethyl, acequinocyl, carbofuran, cyanazine, simazine, atrazine, atrazinedesethyl, Aldrin, DDE (p-p′), DDD (o-p), DDD (p-p′), DDE (o-p), DDT (o-p′), DDT (p-p′), dieldrin, endrin, endrin aldehyde, endrin ketone, isodrin, chlordecone, metribuzin, or mirex(Dodecachlorooctahydro-1H-1,3,4-(epimethanetriyl)cyclobuta[cd]pentalene).

In another preferred embodiment, the organic keto compound (A1a) is selected from acetophenone, benzophenone, butadione, n-butyl acetoacetate, p-chloroacetophenone, chloroacetone, cyclohexanone, methyl cyclohexanone, cyclobutanone, cyclodecanone, cycloheptanone, cyclooctaone, cyclopentanone, cyclopropylmethyl ketone, diethyl ketone, di-isobutyl ketone, dimethyldiketone, dipropylketone, ethyl butyl ketone, ethyl vinyl ketone, ethylidene acetone, 4-fluoropropylphenone, isophorone, 4-methoxy acetophenone, pentoxone, methyl butyl ketone, 3-methyl cyclohexanone, 2-methyl cyclohexanone, methyl ethyl ketone, methyl isoamyl ketone, methyl isobutyl ketone, methyl isopropenyl ketone, methyl n-amyl ketone, methyl n-propyl ketone, methyl vinyl ketone, or 4-(trifluoromethyl)acetophenone; more preferably the organic keto compound (A1a) is selected from acetophenone, benzophenone, butadione, n-butyl acetoacetate, cyclohexanone, methyl cyclohexanone, cyclobutanone, cyclodecanone, cycloheptanone, cyclooctaone, cyclopentanone, cyclopropylmethyl ketone, diethyl ketone, di-isobutyl ketone, dimethyldiketone, dipropylketone, ethyl butyl ketone, isophorone, 4-methoxy acetophenone, pentoxone, methyl butyl ketone, 3-methyl cyclohexanone, 2-methyl cyclohexanone, methyl ethyl ketone, methyl isoamyl ketone, methyl isobutyl ketone, methyl isopropenyl ketone, methyl n-amyl ketone, methyl n-propyl ketone, methyl vinyl ketone, or 4-(trifluoromethyl)acetophenone; even more preferably the organic keto compound (A1a) is selected from acetophenone, benzophenone, n-butyl acetoacetate, cyclohexanone, methyl cyclohexanone, cyclobutanone, cyclodecanone, cycloheptanone, cyclooctaone, cyclopentanone, cyclopropylmethyl ketone, diethyl ketone, di-isobutyl ketone, dimethyldiketone, dipropylketone, ethyl butyl ketone, isophorone, 4-methoxy acetophenone, pentoxone, methyl butyl ketone, methyl ethyl ketone, methyl isoamyl ketone, methyl isobutyl ketone, methyl isopropenyl ketone, methyl n-amyl ketone, methyl n-propyl ketone, methyl vinyl ketone, or 4-(trifluoromethyl)acetophenone; most preferably the organic keto compound (A1a) is selected from acetophenone, benzophenone, n-butyl acetoacetate, cyclohexanone, methyl cyclohexanone, cyclodecanone, cycloheptanone, cyclooctaone, cyclopropylmethyl ketone, diethyl ketone, di-isobutyl ketone, dimethyldiketone, dipropylketone, ethyl butyl ketone, isophorone, 4-methoxy acetophenone, pentoxone, methyl butyl ketone, methyl ethyl ketone, methyl isoamyl ketone, methyl isobutyl ketone, methyl isopropenyl ketone, methyl n-amyl ketone, methyl n-propyl ketone, methyl vinyl ketone, or 4-(trifluoromethyl)acetophenone; and in particular preferably the organic keto compound (A1a) is selected from acetophenone, benzophenone, n-butyl acetoacetate, cyclohexanone, methyl cyclohexanone, cyclodecanone, cycloheptanone, cyclooctaone, cyclopropylmethyl ketone, diethyl ketone, di-isobutyl ketone, dimethyldiketone, dipropylketone, ethyl butyl ketone, isophorone, 4-methoxy acetophenone, pentoxone, methyl butyl ketone, methyl ethyl ketone, methyl isoamyl ketone, methyl isobutyl ketone, methyl isopropenyl ketone, methyl n-amyl ketone, or methyl n-propyl ketone.

In another preferred embodiment, the organic amine (A1b) is selected from aniline, methoxy aniline, n-butyl amine, cyclohexylamine, di-2-ethylhexlamine, diallylamine, N,N-dichloroethylamine, diethanolamine, diethylamine, diethylenetriamine, di-isobutyl amine, dimethylamine, dimethylamine dimer, dipropyl amine, ethanolamine, ethylamine, ethylenediamine, ethyleneimine, N-formyl hexamethyleneimine, isopropyl amine, methylamine, propyl amine, pyridine, quinoline, triethanolamine, triethylamine, trimethyl amine, vinyl amine, or 4-vinyl pyridine, more preferably the organic amine (A1b) is selected from aniline, methoxy aniline, n-butyl amine, cyclohexylamine, di-2-ethylhexlamine, diethanolamine, diethylamine, di-isobutyl amine, dipropyl amine, ethanolamine, ethylamine, ethylenediamine, ethyleneimine, N-formyl hexamethyleneimine, isopropyl amine, methylamine, propyl amine, pyridine, quinoline, triethanolamine, triethylamine, trimethyl amine, vinyl amine, or 4-vinyl pyridine; even more preferably the organic amine (A1b) is selected from aniline, methoxy aniline, n-butyl amine, cyclohexylamine, di-2-ethylhexlamine, diethanolamine, diethylamine, di-isobutyl amine, dipropyl amine, ethanolamine, ethylenediamine, N-formyl hexamethyleneimine, isopropyl amine, methylamine, propyl amine, pyridine, quinoline, triethanolamine, triethylamine, trimethyl amine, vinyl amine, or 4-vinyl pyridine; most preferably the organic amine (A1b) is selected from aniline, methoxy aniline, n-butyl amine, cyclohexylamine, di-2-ethylhexlamine, diethanolamine, di-isobutyl amine, ethanolamine, ethylenediamine, N-formyl hexamethyleneimine, isopropyl amine, methylamine, propyl amine, pyridine, quinoline, triethanolamine, triethylamine, trimethyl amine, vinyl amine, or 4-vinyl pyridine; and in particular the organic amine (A1b) is selected from aniline, methoxy aniline, n-butyl amine, cyclohexylamine, di-2-ethylhexlamine, diethanolamine, di-isobutyl amine, ethanolamine, ethylenediamine, N-formyl hexamethyleneimine, isopropyl amine, methylamine, propyl amine, pyridine, quinoline, triethanolamine, or triethylamine.

In another preferred embodiment, the organic acid (A2a) is selected from formic acid, substituted or unsubstituted, linear or branched C₁-C₂₄ alkyl carboxylic acids, substituted or unsubstituted, linear or branched C₂-C₁₆ alkenyl carboxylic acids, substituted or unsubstituted C₅-C₂₄ cycloalkyl carboxylic acids, substituted or unsubstituted C₅-C₂₄ cycloalkenyl carboxylic acids, substituted or unsubstituted C₆-C₂₄ aryl carboxylic acids, or substituted or unsubstituted C₇-C₂₄ arylalkyl carboxylic acids; more preferably the organic acid (A2a) is selected from formic acid, substituted or unsubstituted, linear or branched C₁-C₂₄ alkyl carboxylic acids, substituted or unsubstituted, linear or branched C₂-C₁₆ alkenyl carboxylic acids, substituted or unsubstituted C₅-C₂₄ cycloalkyl carboxylic acids, substituted or unsubstituted C₆-C₂₄ aryl carboxylic acids, or substituted or unsubstituted C₇-C₂₄ arylalkyl carboxylic acids; most preferably the organic acid (A2a) is selected from formic acid, substituted or unsubstituted, linear or branched C₁-C₂₄ alkyl carboxylic acids, substituted or unsubstituted, linear or branched C₂-C₁₄ alkenyl carboxylic acids, substituted or unsubstituted C₅-C₂₄ cycloalkyl carboxylic acids, or substituted or unsubstituted C₇-C₂₄ arylalkyl carboxylic acids; and in particular preferably the organic acid (A2a) is selected from formic acid, substituted or unsubstituted, linear or branched C₁-C₂₄ alkyl carboxylic acids, substituted or unsubstituted C₅-C₂₄ cycloalkyl carboxylic acids, or unsubstituted C₇-C₂₄ arylalkyl carboxylic acids.

In another preferred embodiment, the substituted or unsubstituted, linear or branched C₁-C₂₄ alkyl carboxylic acids are mono carboxylic acid, or dicarboxylic acid or polycarboxylic acid.

In another preferred embodiment, the substituted or unsubstituted, linear or branched C₁-C₂₄ alkyl carboxylic acids are selected from CH₃COOH, CH₃CH₂COOH, CH₃(CH₂)₂COOH, CH₃(CH₂)₃COOH, CH₃(CH₂)₄COOH, CH₃(CH₂)₅COOH, CH₃(CH₂)₆COOH, CH₃(CH₂)₇COOH, CH₃(CH₂)₅COOH, CH₃(CH₂)₉COOH, CH₃(CH₂)₁₀COOH, CH₃(CH₂)₁₁COOH, CH₃(CH₂)₁₂COOH, CH₃(CH₂)₁₃COOH, CH₃(CH₂)₁₄COOH, CH₃(CH₂)₁₅COOH, CH₃(CH₂)₁₆COOH, CH₃(CH₂)₁₇COOH, CH₃(CH₂)₁₈COOH, CH₃(CH₂)₁₉COOH, CH₃(CH₂)₂₀COOH, CH₃(CH₂)₂₁COOH, CH₃(CH₂)₂₂COOH, HOCH₂COOH, CH₃CH(OH)COOH, HOOCCOOH, CH₂(OH)CH₂COOH, CH₂(OH)C(CH₃)₂COOH, CH₂(OH)CH(OH)COOH, HOOCCH₂COOH, HOOCCH(OH)COOH, (CH₃)₂CHCOOH, CH₃CH₂CH(OH)COOH, CH₃CH(OH)CH₂COOH, HOCH₂(CH₂)₂COOH, CH₃COCH₂COOH, HOOC(CH₂)₂COOH, HOOCCH(CH₃)COOH, HOOCCH₂CH(OH)COOH, HOOC(CHOH)₂COOH, HOOCCH₂COCOOH, (CH₃)₂CHCH₂COOH, CH₃CH₂CH(CH₃)COOH, (CH₃)₃CCOOH, CH₃CH₂CH(OH)CH₂COOH, CH₃CH(OH)(CH₂)₂COOH, (CH₃)₂C(OH)CH₂COOH, HOOC(CH₂)₃COOH, HOOC(CH₂)₄COOH, (HO)C(COOH)((CH₂)COOH)₂, HOOCCH(OH)CH(COOH)CH₂COOH, HOOC(CH₂)₅COOH, or HOOC(CH₂)₅COOH; more preferably the substituted or unsubstituted, linear or branched C₁-C₂₄ alkyl carboxylic acids are selected from CH₃COOH, CH₃CH₂COOH, CH₃(CH₂)₂COOH, CH₃(CH₂)₃COOH, CH₃(CH₂)₄COOH, CH₃(CH₂)₅COOH, CH₃(CH₂)₆COOH, CH₃(CH₂)₁₀COOH, CH₃(CH₂)₁₂COOH, CH₃(CH₂)₁₄COOH, CH₃(CH₂)₁₆COOH, HOCH₂COOH, CH₃CH(OH)COOH, CH₂(OH)CH₂COOH, CH₂(OH)C(CH₃)₂COOH, CH₂(OH)CH(OH)COOH, HOOCCH₂COOH, HOOCCH(OH)COOH, (CH₃)₂CHCOOH, CH₃CH₂CH(OH)COOH, CH₃CH(OH)CH₂COOH, HOCH₂(CH₂)₂COOH, HOOC(CH₂)₂COOH, HOOCCH(CH₃)COOH, HOOCCH₂CH(OH)COOH, HOOC(CHOH)₂COOH, HOOCCH, COCOOH, (CH₃)₂CHCH₂COOH, CH₃CH₂CH(CH₃)COOH, (CH₃)₃CCOOH, CH₃CH₂CH(OH)CH₂COOH, CH₃CH(OH)(CH₂)₂COOH, (CH₃)₂C(OH)CH₂COOH, HOOC(CH₂)₃COOH, HOOC(CH₂)₄COOH, (HO)C(COOH)((CH₂)COOH)₂, HOOCCH(OH)CH(COOH)CH₂COOH, HOOC(CH₂)₅COOH, or HOOC(CH₂)₅COOH; most preferably the substituted or unsubstituted, linear or branched C₁-C₂₄ alkyl carboxylic acids are selected from CH₃COOH, CH₃CH₂COOH, CH₃(CH₂)₁₀COOH, CH₃(CH₂)₁₂COOH, CH₃(CH₂)₁₄COOH, CH₃(CH₂)₁₆COOH, HOOCCH₂COOH, HOOCCH(OH)COOH, (CH₃)₂CHCOOH, CH₃CH₂CH(OH)COOH, CH₃CH(OH)CH₂COOH, HOCH₂(CH₂)₂COOH, CH₂(OH)C(CH₃)₂COOH, HOOC(CH₂)₂COOH, HOOCCH(CH₃)COOH, HOOCCH₂CH(OH)COOH, HOOC(CHOH)₂COOH, HOOCCH₂COCOOH, (CH₃)₂CHCH₂COOH, CH₃CH₂CH(CH₃)COOH, (CH₃)₃CCOOH, CH₃CH₂CH(OH)CH₂COOH, CH₃CH(OH)(CH₂)₂COOH, (CH₃)₂C(OH)CH₂COOH, HOOC(CH₂)₃COOH, HOOC(CH₂)₄COOH, (HO)C(COOH)((CH₂)COOH)₂, HOOCCH(OH)CH(COOH)CH₂COOH, HOOC(CH₂)₅COOH, or HOOC(CH₂)₅COOH; and in particular preferably the substituted or unsubstituted, linear or branched C₁-C₂₄ alkyl carboxylic acids are selected from CH₃COOH, CH₂(OH)C(CH₃)₂COOH, HOOC(CH₂)₂COOH, HOOCCH(CH₃)COOH, HOOCCH₂CH(OH)COOH, (CH₃)₂CHCH₂COOH, (CH₃)₃CCOOH, CH₃CH₂CH(OH)CH₂COOH, (CH₃)₂C(OH)CH₂COOH, HOOC(CH₂)₃COOH, HOOC(CH₂)₄COOH, (HO)C(COOH)((CH₂)COOH)₂, or HOOCCH(OH)CH(COOH)CH₂COOH.

In another preferred embodiment, the substituted or unsubstituted, linear or branched alkenyl carboxylic acids are selected from propenoic acid, crotonic acid, isocrotonic acid, methacrylic acid, vinyl acetic acid, fumaric acid, maleic acid, prop-1-ene-1,2,3-tricarboxylic acid, (2E,4E)-hexa-2,4-dienoic acid, cinnamic acid, myristoleic acid, palmitoleic acid, or sapienic acid, more preferably the substituted or unsubstituted, linear or branched alkenyl carboxylic acids are selected from propenoic acid, vinyl acetic acid, fumaric acid, maleic acid, prop-1-ene-1,2,3-tricarboxylic acid, (2E,4E)-hexa-2,4-dienoic acid, or cinnamic acid, and most preferably the substituted or unsubstituted, linear or branched alkenyl carboxylic acids are selected from vinyl acetic acid, fumaric acid, maleic acid, or cinnamic acid.

In another preferred embodiment, the substituted or unsubstituted C₅-C₂₄ cycloalkyl carboxylic acids are selected from cyclopentane carboxylic acid,1,2-cyclopentane dicarboxylic acid, cyclohexane carboxylic acid, 3-methyl cyclohexane carboxylic acid, 4-methyl cyclohexane carboxylic acid, 1,4-cyclohexane dicarboxylic acid, or 4-hydroxy cyclohexane carboxylic acid.

In an embodiment, the substituted or unsubstituted C₆-C₂₄ aryl carboxylic acids selected from 3-hydroxy benzoic acid, 4-hydroxy benzoic acid, 2,3-dihydroxy benzoic acid, 2,4-dihydroxy benzoic acid, 2,4-dihydroxy benzoic acid, 2,6-dihydroxy benzoic acid, 3,4-dihydroxy benzoic acid, 3,5-dihydroxy benzoic acid, 3,6-dihydroxy benzoic acid, phthalic acid, gallic acid, toluic acid, isophthalic acid, terephthalic acid, salicylic acid, acetyl salicylic acid, 3-methoxy benzoic acid, or 4-methoxy benzoic acid.

In another preferred embodiment, the substituted or unsubstituted C₇-C₂₄ arylalkyl carboxylic acids selected from phenyl acetic acid, 2-phenyl propanoic acid, 2-hydroxy phenyl acetic acid, 3-hydroxy phenyl acetic acid, 4-hydroxy phenyl acetic acid, 3-chloro-4-hydroxyphenyl acetic acid, indole-3-acetic acid, 3,5-dimethoxy-4-hydroxyphenyl acetic acid, α-hydroxyphenyl acetic acid, or 3-ethoxy-4-hydroxyphenyl acetic acid; more preferably the substituted or unsubstituted C₇-C₂₄ arylalkyl carboxylic acids selected from phenyl acetic acid, 2-phenyl propanoic acid, 4-hydroxy phenyl acetic acid, indole-3-acetic acid, or α-hydroxyphenyl acetic acid; most preferably the substituted or unsubstituted C₇-C₂₄ arylalkyl carboxylic acids selected from phenyl acetic acid, 4-hydroxy phenyl acetic acid, indole-3-acetic acid, or α-hydroxyphenyl acetic acid; and in particular preferably the substituted or unsubstituted C₇-C₂₄ arylalkyl carboxylic acids selected from phenyl acetic acid, or 4-hydroxy phenyl acetic acid.

In another preferred embodiment, the organic acid (A2a) is selected from acetic acid, formic acid, D,L-lactic acid, nonanoic acid, dodecanoic acid, hydroxy pivalic acid, or phenyl acetic acid.

In an embodiment, the organic alcohol (A2b) is selected from substituted or unsubstituted, linear or branched C₁-C₂₄ alkyl alcohols, substituted or unsubstituted, linear or branched C₃-C₂₄ alkenyl alcohols, substituted or unsubstituted C₅-C₂₄ cycloalkyl alcohols, substituted or unsubstituted C₅-C₂₄ cycloalkenyl alcohols, substituted or unsubstituted C₆-C₂₄ aryl alcohols (phenol), or substituted C₇-C₂₄ arylalkyl alcohols; and more preferably organic alcohol (A2b) is selected from substituted or unsubstituted, linear or branched C₄-C₂₄ alkyl alcohols, substituted or unsubstituted, linear or branched C₃-C₂₄ alkenyl alcohols, substituted or unsubstituted C₅-C₂₄ cycloalkyl alcohols, substituted or unsubstituted C₆-C₂₄ aryl alcohols, or substituted C₇-C₂₄ arylalkyl alcohols.

In another preferred embodiment, the organic alcohol (A2b) is selected from allyl alcohol, t-butyl cyclohexanol, xylitol, dextrose, 1,3-benzenediol, mannitol, benzyl alcohol, 2,3-butadiene-1-ol, 1,3-butanediol, 1,4-butanediol, t-butyl alcohol, 2-phenylethanol, thymol, 2-methoxy-4-methyl phenol, 2-sec-butyl phenol, 4-nitrophenol, 4-methyl cyclohexanol, butoxyethoxy propanol, 3-butoxy butanol, m-cresol, cyclohexanol, 2-cyclopentenyl alcohol, diacetone alcohol, 2-(diethyamino)ethanol, diethylene glycol, 2,6-dimethyl phenol, 3,4-dimethyl phenol, dipropylene glycol, dipropylene glycol methyl ether, ethanol, ethanolamine, 1-ethoxy-2-propanol, 2-ethyl-1-butanol, ethylene glycol, glycerol, hexylene glycol, 3-methyl-1-butanol, isobutyl alcohol, isooctyl alcohol, methanol, o-methoxyphenol, 3-methyl allyl alcohol, 2-methyl-1-butanol, 2-methyl-1-propanol, 2-methyl-2-butanol, 2-octanol, 1-pentanol, 2-pentanol, phenol, 2-phenoxy ethanol, 1-propanol, 2-propanol, propylene glycol, cuminol, triethanolamine, triethylene glycol, triethylene glycol monomethylether, 2-bromoallyl alcohol, 1,3-butanedol, 3-chloroallyl alcohol, 2-chloroallyl alcohol, 3-chloro-1-propanol, 4-chlorobnzyl alcohol, 2-chlorophenol, 1-decanol, 2-decanol, diisobutyl carbinol, 2-ethylhexanol, menthol, carvacrol, 2-ethyl phenol, o-methoxy, phenol, methyl isobutyl carbinol, or 4-isopropylbenzylmethanol; more preferably the organic alcohol (A2b) is selected from t-butyl cyclohexanol, xylitol, dextrose, 1,3-benzenediol, mannitol, 2,3-butadiene-1-ol, 1,3-butanediol, 1,4-butanediol, t-butyl alcohol, 2-phenylethanol, thymol, 2-methoxy-4-methyl phenol, 2-sec-butyl phenol, 4-nitrophenol, 4-methyl cyclohexanol, butoxyethoxy propanol, 3-butoxy butanol, m-cresol, cyclohexanol, 2-cyclopentenyl alcohol, diacetone alcohol, 2-(diethyamino)ethanol, diethylene glycol, 2,6-dimethyl phenol, 3,4-dimethyl phenol, dipropylene glycol, dipropylene glycol methyl ether, ethanol, ethanolamine, 1-ethoxy-2-propanol, 2-ethyl-1-butanol, ethylene glycol, glycerol, hexylene glycol, 3-methyl-1-butanol, isobutyl alcohol, isooctyl alcohol, methanol, o-methoxyphenol, 3-methyl allyl alcohol, 2-methyl-1-butanol, 2-methyl-1-propanol, 2-methyl-2-butanol, 2-octanol, 1-pentanol, 2-pentanol, phenol, 2-phenoxy ethanol, 1-propanol, 2-propanol, propylene glycol, cuminol, triethanolamine, triethylene glycol, triethylene glycol monomethylether, 2-bromoallyl alcohol, 1,3-butanedol, 3-chloroallyl alcohol, 2-chloroallyl alcohol, 3-chloro-1-propanol, 4-chlorobnzyl alcohol, 2-chlorophenol, 1-decanol, 2-decanol, diisobutyl carbinol, menthol, carvacrol, 2-ethyl phenol, o-methoxy, phenol, methyl isobutyl carbinol, or 4-isopropylbenzylmethanol; even more preferably the organic alcohol (A2b) is selected from t-butyl cyclohexanol, xylitol, dextrose, 1,3-benzenediol, mannitol, t-butyl alcohol, 2-phenylethanol, thymol, 2-methoxy-4-methyl phenol, 2-sec-butyl phenol, 4-nitrophenol, 4-methyl cyclohexanol, m-cresol, cyclohexanol, 2-cyclopentenyl alcohol, 2-(diethyamino)ethanol, diethylene glycol, 2,6-dimethyl phenol, 3,4-dimethyl phenol, dipropylene glycol, dipropylene glycol methyl ether, ethanol, ethanolamine, ethylene glycol, glycerol, hexylene glycol, 3-methyl-1-butanol, isobutyl alcohol, isooctyl alcohol, methanol, o-methoxyphenol, 3-methyl allyl alcohol, 2-methyl-1-butanol, 2-methyl-1-propanol, 2-methyl-2-butanol, 2-octanol, 1-pentanol, 2-pentanol, phenol, 2-phenoxy ethanol, 1-propanol, 2-propanol, propylene glycol, cuminol, triethanolamine, triethylene glycol, triethylene glycol monomethylether, 1-decanol, 2-decanol, menthol, carvacrol, 2-ethyl phenol, o-methoxy, phenol, methyl isobutyl carbinol, or 4-isopropylbenzylmethanol; most preferably the organic alcohol (A2b) is selected t-butyl cyclohexanol, xylitol, dextrose, mannitol, t-butyl alcohol, 2-phenylethanol, thymol, 2-methoxy-4-methyl phenol, 2-sec-butyl phenol, 4-nitrophenol, 4-methyl cyclohexanol, m-cresol, cyclohexanol, 2-cyclopentenyl alcohol, diethylene glycol, 2,6-dimethyl phenol, dipropylene glycol, dipropylene glycol methyl ether, ethanol, ethylene glycol, glycerol, hexylene glycol, isobutyl alcohol, isooctyl alcohol, methanol, o-methoxyphenol, 2-octanol, 1-pentanol, 2-pentanol, phenol, 2-phenoxy ethanol, 1-propanol, 2-propanol, propylene glycol, cuminol, triethanolamine, triethylene glycol, triethylene glycol monomethylether, 1-decanol, 2-decanol, menthol, carvacrol, 2-ethyl phenol, o-methoxy, phenol, methyl isobutyl carbinol, or 4-isopropylbenzylmethanol; and in particular preferably the organic alcohol (A2b) is selected t-butyl cyclohexanol, xylitol, dextrose, mannitol, t-butyl alcohol, 2-phenylethanol, thymol, 2-methoxy-4-methyl phenol, 2-sec-butyl phenol, 4-nitrophenol, 4-methyl cyclohexanol, m-cresol, cyclohexanol, 2-cyclopentenyl alcohol, diethylene glycol, 2,6-dimethyl phenol, dipropylene glycol, dipropylene glycol methyl ether, ethanol, ethylene glycol, glycerol, hexylene glycol, isobutyl alcohol, isooctyl alcohol, methanol, o-methoxyphenol, phenol, 2-phenoxy ethanol, cuminol, triethylene glycol, triethylene glycol monomethylether, menthol, carvacrol, 2-ethyl phenol, o-methoxy, phenol, methyl isobutyl carbinol, or 4-isopropylbenzylmethanol.

In an embodiment, the organic ester (A2c) is selected from alkyl and aryl esters of substituted or unsubstituted, linear or branched C₁-C₂₄ alkyl carboxylic acid, alkyl and aryl esters of substituted or unsubstituted, linear or branched C₂-C₂₄ alkenyl carboxylic acid, alkyl and aryl esters of substituted or unsubstituted C₅-C₂₄ cycloalkyl carboxylic acid, alkyl and aryl esters of substituted or unsubstituted C₅-C₂₄ cycloalkenyl carboxylic acid, alkyl and aryl esters of substituted or unsubstituted C₆-C₂₄ aryl carboxylic acid, or alkyl or aryl esters of substituted, or unsubstituted C₇-C₂₄ arylalkyl carboxylic acid.

In another preferred embodiment, the organic ester (A2c) is selected from butyl lactate, n-butyl salicylate, ethyl lactate, methyl formate, methyl salicylate, allyl acetate, allyl acetoacetate, allyl formate, amyl acetate, benzyl butyl phthalate, benzyl methacrylate, n-butyl acetate, sec-butyl acetate, n-butyl acetoacetate, dibutyl fumarate, dibutyl phthalate, dibutyl sebacate, dibutyl stearate, diethyl phthalate, dimethyl phthalate, dioctyl phthalate, ethyl cinnamate, ethyl formate, glycidyl methacrylate, isoamyl acetate, or methyl benzoate; more preferably the organic ester (A2c) is selected from butyl lactate, n-butyl salicylate, ethyl lactate, methyl formate, methyl salicylate, amyl acetate, benzyl butyl phthalate, benzyl methacrylate, n-butyl acetate, sec-butyl acetate, n-butyl acetoacetate, dibutyl fumarate, dibutyl phthalate, dibutyl sebacate, dibutyl stearate, diethyl phthalate, dimethyl phthalate, dioctyl phthalate, ethyl cinnamate, ethyl formate, glycidyl methacrylate, isoamyl acetate, or methyl benzoate; even more preferably the organic ester (A2c) is selected from butyl lactate, n-butyl salicylate, ethyl lactate, methyl salicylate, amyl acetate, dibutyl fumarate, dibutyl sebacate, dibutyl stearate, diethyl phthalate, dimethyl phthalate, dioctyl phthalate, ethyl cinnamate, isoamyl acetate, or methyl benzoate; most preferably the organic ester (A2c) is selected from butyl lactate, n-butyl salicylate, ethyl lactate, methyl salicylate, ethyl cinnamate, isoamyl acetate, or methyl benzoate; and in particular preferably the organic ester (A2c) is selected from butyl lactate, n-butyl salicylate, ethyl lactate, methyl salicylate, or methyl benzoate.

In an embodiment, the organic ether (A2d) has C₅-C₃₀ carbon atoms.

In another preferred embodiment, the organic ether (A2d) is selected from triethylene glycol monomethylether, p-methoxyaniline, diethylene glycol hexylether, diethylene glycol monobutyllether, diethylene glycol monomethylether, diethylene glycol monopropylether, 1,2-dimethoxy benzene, 4-methoxy acetophenone, ethylene glycol monobenzyl ether, ethylene glycol mono-t-butyl ether, ethylene glycol monobutyl ether, ethylene glycol monoethyl ether, allyl ethylether, allyl methylether, butenyl methyl ether, butyl isopropenyl ether, di-n-butyl ether, diphenyl ether, di(2-methoxyethyl)ether, diallyl ether, dibenzyl ether, diethylene glycol butyl ether acetate, diethylene glycol divinyl ether, diethylene glycol dibutyl ether, diethylene glycol methyl t-butyl ether, diethylene glycol diethyl ether, diethylene glycol hexyl ether, diethylene glycol monobutyl ether, diethylene glycol monoethyl ether, diethylene glycol monoethyl ether acetate, di propylene glycol monomethyl ether acetate, ethylene glycol butyl ether acetate, ethylene glycol butyl ethyl ether, ethylene glycol di-t-butyl ether, ethylene glycol dibutyl ether, ethylene glycol butyl methyl ether, ethylene glycol diethyl ether, ethylene glycol methyl t-butyl ether, ethylene glycol mono-2-ethyl hexyl ether, ethylene glycol monoethyl ether acrylate, ethylene glycol monoisobutyl ether, anisole, 4-ethoxy acetophenone, 4-methoxy acetophenone, 4-methoxy benzonitrile, nonyl phenoxy ethanol, or bis-(m-phenoxyphenyl) ether; more preferably the organic ether (A2d) is selected from p-methoxyaniline, diethylene glycol monomethylether, 1,2-dimethoxy benzene, 4-methoxy acetophenone, butenyl methyl ether, butyl isopropenyl ether, di-n-butyl ether, diphenyl ether, di(2-methoxyethyl)ether, dibenzyl ether, ethylene glycol butyl ethyl ether, ethylene glycol di-t-butyl ether, ethylene glycol dibutyl ether, ethylene glycol butyl methyl ether, ethylene glycol diethyl ether, ethylene glycol methyl t-butyl ether, ethylene glycol mono-2-ethyl hexyl ether, ethylene glycol monoethyl ether acrylate, ethylene glycol monoisobutyl ether, anisole, 4-ethoxy acetophenone, 4-methoxy acetophenone, 4-methoxy benzonitrile, nonyl phenoxy ethanol, or bis-(m-phenoxyphenyl) ether; most preferably the organic ether (A2d) is selected from p-methoxyaniline, di-n-butyl ether, diphenyl ether, di(2-methoxyethyl)ether, dibenzyl ether, ethylene glycol methyl t-butyl ether, ethylene glycol mono-2-ethyl hexyl ether, ethylene glycol monoethyl ether acrylate, ethylene glycol monoisobutyl ether, anisole, 4-ethoxy acetophenone, 4-methoxy acetophenone, 4-methoxy benzonitrile, nonyl phenoxy ethanol, or bis-(m-phenoxyphenyl) ether; and in particular preferably the organic ether (A2d) is selected from p-methoxyaniline, di-n-butyl ether, diphenyl ether, di(2-methoxyethyl)ether, anisole, 4-ethoxy acetophenone, 4-methoxy acetophenone, 4-methoxy benzoni trile, nonyl phenoxy ethanol, or bis-(m-phenoxyphenyl) ether.

The ability of a solvent to dissolve a given substance, e.g. a biocide, may conveniently be evaluated by parameter consideration according to the so-called “Hansen system”, which is described in “Hansen Solubility Parameters—A Users Handbook”, published by CRC Press (2000). According to the Hansen system, a solvent or mixture of solvents may be described by three solubility parameters δ d (dispersion parameter), δ p (polarity parameter) and δ h (hydrogen bonding parameter).

In an embodiment, the organic keto compound (A1a) has Hansen solubility parameters in the ranges δ d 13.5-20 MPa^{1/2}, δ p 3.5-12.5 MPa^{1/2}, and δ h 3.5-7.0 MPa^{1/2}.

In an embodiment, the organic amine (A1b) has Hansen solubility parameters in the ranges δ d 14.5-20 MPa^{1/2}, δ p 0.8-15.5 MPa^{1/2}, and δ h 1.8-21.2 MPa^{1/2}.

In an embodiment, the organic acid (A2a) has Hansen solubility parameters in the ranges δ d 13-25 MPa^{1/2}, δ p 3-15 MPa^{1/2} and δ h10-30 MPa^{1/2}.

In another preferred embodiment, the organic alcohol (A2b) has Hansen solubility parameters in the ranges δ d 14-20 MPa^{1/2}, δ p 4-12.5 MPa^{1/2} and δ h10-30 MPa^{1/2}.

In another preferred embodiment, the organic ester (A2c) has Hansen solubility parameters in the ranges δ d 13-19 MPa^{1/2}, δ p 3-9 MPa^{1/2}, and δ h 3.5-14 MPa^{1/2}.

In another preferred embodiment, the organic ether (A2d) has Hansen solubility parameters in the ranges δ d 14-20 MPa^{1/2}, δ p 3-12 MPa^{1/2}, and δ h 3-15 MPa^{1/2}.

In another preferred embodiment, the composition (C) further comprises at least one emulsifier (D) in an amount of 1.0 to 50.0% by weight, based on the overall weight of the composition (C); more preferably the composition (C) further comprises at least one emulsifier (D) in an amount of 1.0 to 40.0% by weight, based on the overall weight of the composition (C); even more preferably the composition (C) further comprises at least one emulsifier (D) in an amount of 5.0 to 30.0% by weight, based on the overall weight of the composition (C); most preferably the composition (C) further comprises at least one emulsifier (D) in an amount of 10.0 to 30.0% by weight, based on the overall weight of the composition (C); and in particular the composition (C) further comprises at least one emulsifier (D) in an amount of 10.0 to 25.0% by weight, based on the overall weight of the composition (C).

In an embodiment, the emulsifier (D) is selected from anionic emulsifier, or a non-ionic emulsifier.

In another preferred embodiment, the anionic emulsifier may be any known in the art and typically selected from alkali, alkaline earth or ammonium salts of fatty acids, such as potassium stearate, alkyl sulfates, alkyl ether sulfates, alkylsulfonates or iso-alkylsulfonates, alkylnaphthalenesulfonates, alkyl methyl ester sulfonates, acyl glutamates, alkylsulfosuccinates, sarcosinates such as sodium lauroyl sarcosinate or taurates, or combinationcombination thereof.

In another preferred embodiment, the anionic emulsifier is a calcium dodecylbenzene sulfonate (DDBSA) such as Ninate 401 A, Agnique® ABS 60, and Agnique® ABS 70C.

In another preferred embodiment, the non-ionic emulsifier may be any known in the art and typically selected from alkoxylated animal or vegetable fats and oils such as corn oil ethoxylates, soybean oil ethoxylates, castor oil ethoxylates, tallow fatty ethoxylates, glycerol esters such as glycerol monostearate, fatty alcohol alkoxylates and oxoalcohol alkoxylates, fatty acid alkoxylates such as oleic acid ethoxylates, alkylphenol alkoxylates such as isononylphenol ethoxylates, fatty amine alkoxylates, fatty acid amide alkoxylates, sugar surfactants such as sorbitan fatty acid esters (e.g. sorbitan monooleate, and sorbitan tristearate), polyoxyethylene sorbitan fatty acid esters, alkyl polyglycosides, N-alkylgluconamides, alkylmethyl sulfoxides, alkyldimethylphosphine oxides such as tetradecyldimethylphosphine oxide, or combinationcombination thereof.

In another preferred embodiment, presently claimed composition (C) optionally comprises auxiliaries (G) pH-adjusters, thickeners, antifreeze agents, preservatives, antifoaming and defoamer agents, spreading agents, stickers, UV-protectants, and/or stabilizers. Such auxiliaries are generally known within the art of formulation chemistry, and although a specific ingredient is classified as falling within one category, it may well serve the purpose of any of the others.

In another preferred embodiment, the thickeners and film-forming agents are selected from starches, gums, casein and gelatine, polyvinyl pyrrolidones, polyethylene and polypropylene glycols, polyacrylates, polyacrylamides, polyethyleneimines, polyvinyl alcohols, polyvinyl acetates, methyl-, hydroxyethyl- or hydroxypropylcelluloses or derivatives thereof Examples of the antifreezing agent include ethylene glycol, diethylene glycol, propylene glycol and the like.

In another preferred embodiment, the preservatives are selected from methyl and propyl parahydroxybenzoate, 2-bromo-2-nitro-propane-1,3-diol, sodium benzoate, formaldehyde, glutaraldehyde, 0-phenylphenol, benzisothiazolinones, 5-chloro-2-methyl-4-isothiazolin-3-one, pentachlorophenol, 2-4-dichlorobenzylalcohol, sorbic acid, or derivatives thereof.

In another preferred embodiment, the anti-foaming and defoamer agents are silicone-based compounds e.g. polyalkylsiloxanes.

In another preferred embodiment, the stabilizers selected from phthalate(s) such as diethylhexyl phthalate, ethylhexyl phthalate, dimethyl phthalate, diethyl phthalate, butylbenzyl phthalate, dibutyl phthalate, diisononyl phthalate, or dioctyl phthalate. Preferred are dimethyl phthalate, diethyl phthalate or diisononyl phthalate, and especially diethyl phthalate.

In another preferred embodiment, the composition (C) has a viscosity in the range of 1 cps to 200 cps at 25° C. at atmospheric pressure; more preferably the composition has a viscosity in the range of 1 cps to 150 cps at 25° C. at atmospheric pressure; even more preferably the composition has a viscosity in the range of 1 cps to 100 cps at 25° C. at atmospheric pressure; most preferably the composition has a viscosity in the range of 1 cps to 80 cps at 25° C. at atmospheric pressure; and in particular preferably the composition has a viscosity in the range of 1 cps to 50 cps at 25° C. at atmospheric pressure. The viscosity is measured according to the method CIPAC MT 192-Scope.

In another preferred embodiment, the presently claimed invention is directed to an emulsifiable biocidal composition which does not contain environmental hazardous aromatic hydrocarbon as solvent.

In an embodiment, the presently claimed invention is directed to the use of a solvent system (A) for preparing an emulsifiable concentrate comprising at least one biocide,
wherein the solvent system (A) comprises:
(A1) a first component selected from an organic keto compound (A1a), an organic amine (A1b) or a combination thereof; and
(A2) a second component selected from an organic acid (A2a), an alcohol (A2b), an ester (A2c), an ether (A2d), or a combination thereof;
wherein Hansen solubility parameters of the first component are in the ranges of δ d 13-20 MPa^{1/2}, δ p 0.2-23 MPa^{1/2} and δ h 1-24 MPa^{1/2} and the Hansen solubility parameters of the second component (A2) are in the ranges of δ d 13-25 MPa^{1/2}, δ p 1-15 MPa^{1/2}, and δ h 2-30 MPa^{1/2},
wherein the mole ratio of total amount of A1 to the total amount of A2 is in the range of 1.0:5.0 to 5.0:1.0; and more preferably the presently claimed invention is directed to the use of a solvent system (A) for preparing an emulsifiable concentrate comprising at least one biocide, wherein the solvent system (A) comprises:
(A1) a first component selected from an organic keto compound (A1a), an organic amine (A1b) or a combination thereof; and
(A2) a second component selected from an organic acid (A2a), an alcohol (A2b), an ester (A2c), an ether (A2d), or a combination thereof;
wherein Hansen solubility parameters of the first component are in the ranges of δ d 13-20 MPa^{1/2}, δ p 0.2-23 MPa^{1/2} and δ h 1-24 MPa^{1/2} and the Hansen solubility parameters of the second component (A2) are in the ranges of δ d 13-25 MPa^{1/2}, δ p 1-15 MPa^{1/2}, and δ h 2-30 MPa^{1/2},
wherein the mole ratio of total amount of A1 to the total amount of A2 is in the range of 1.0:3.0 to 3.0:1.0.

In an embodiment, the presently claimed invention is directed to the use of a solvent system (A) for preparing an emulsifiable concentrate comprising at least one biocide,
wherein the solvent system (A) comprises:
(A1) a first component, an organic keto compound (A1a); and
(A2) a second component selected from an organic acid (A2a), an alcohol (A2b), an ester (A2c), an ether (A2d), or a combination thereof;
wherein Hansen solubility parameters of the first component are in the ranges of δ d 13-20 MPa^{1/2}, δ p 0.2-23 MPa^{1/2} and δ h 1-24 MPa^{1/2} and the Hansen solubility parameters of the second component (A2) are in the ranges of δ d 13-25 MPa^{1/2}, δ p 1-15 MPa^{1/2}, and δ h 2-30 MPa^{1/2},
wherein the mole ratio of total amount of A1 to the total amount of A2 is in the range of 1.0:5.0 to 5.0:1.0, preferably 1.0:3.0 to 3.0:1.0, more preferably 1.0:2.0 to 2.0:1.0; and more preferably the presently claimed invention is directed to the use of a solvent system (A) for preparing an emulsifiable concentrate comprising at least one biocide,
wherein the solvent system (A) comprises:
(A1) a first component, an organic keto compound (A1a); and
(A2) a second component selected from an organic acid (A2a), an alcohol (A2b), an ester (A2c), an ether (A2d), or a combination thereof;
wherein Hansen solubility parameters of the first component are in the ranges of δ d 13-20 MPa^{1/2}, δ p 0.2-23 MPa^{1/2} and δ h 1-24 MPa^{1/2} and the Hansen solubility parameters of the second component (A2) are in the ranges of δ d 13-25 MPa^{1/2}, δ p 1-15 MPa^{1/2}, and δ h 2-30 MPa^{1/2},
wherein the mole ratio of total amount of A1 to the total amount of A2 is in the range of 1.0:3.0 to 3.0:1.0, preferably 1.0:3.0 to 3.0:1.0, more preferably 1.0:2.0 to 2.0:1.0.

In the above embodiment, the organic keto compound (A1a) is selected from acetophenone, benzophenone, n-butyl acetoacetate, cyclohexanone, methyl cyclohexanone, cyclodecanone, cycloheptanone, cyclooctaone, cyclopropylmethyl ketone, diethyl ketone, di-isobutyl ketone, dimethyldiketone, dipropylketone, ethyl butyl ketone, isophorone, pentoxone, methyl butyl ketone, methyl ethyl ketone, methyl isoamyl ketone, methyl isobutyl ketone, methyl isopropenyl ketone, methyl n-amyl ketone, or methyl n-propyl ketone, preferably, acetophenone, benzophenone, cyclohexanone, ethyl butyl ketone or methyl n-propyl ketone.

In another embodiment, the presently claimed invention is directed to the use of a solvent system (A) for preparing an emulsifiable concentrate comprising at least one biocide, wherein the solvent system (A) comprises:
(A1) a first component, an organic amine (A1b); and
(A2) a second component selected from an organic acid (A2a), an alcohol (A2b), an ester (A2c), an ether (A2d), or a combination thereof;
wherein Hansen solubility parameters of the first component are in the ranges of δ d 13-20 MPa^{1/2}, δ p 0.2-23 MPa^{1/2} and δ h 1-24 MPa^{1/2} and the Hansen solubility parameters of the second component (A2) are in the ranges of δ d 13-25 MPa^{1/2}, δ p 1-15 MPa^{1/2}, and δ h 2-30 MPa^{1/2},
wherein the mole ratio of total amount of A1 to the total amount of A2 is in the range of 1.0:5.0 to 5.0:1.0; and more preferably the presently claimed invention is directed to the use of a solvent system (A) for preparing an emulsifiable concentrate comprising at least one biocide, wherein the solvent system (A) comprises:
(A1) a first component, an organic amine (A1b); and
(A2) a second component selected from an organic acid (A2a), an alcohol (A2b), an ester (A2c), an ether (A2d), or a combination thereof;
wherein Hansen solubility parameters of the first component are in the ranges of δ d 13-20 MPa^{1/2}, δ p 0.2-23 MPa^{1/2} and δ h 1-24 MPa^{1/2} and the Hansen solubility parameters of the second component (A2) are in the ranges of δ d 13-25 MPa^{1/2}, δ p 1-15 MPa^{1/2}, and δ h 2-30 MPa^{1/2},
wherein the mole ratio of total amount of A1 to the total amount of A2 is in the range of 1.0:3.0 to 3.0:1.0, preferably 1.0:3.0 to 3.0:1.0, more preferably 1.0:2.0 to 2.0:1.0.

In the above embodiment, the organic amine compound (A1b) aniline, methoxy aniline, n-butyl amine, cyclohexylamine, di-2-ethylhexlamine, diethanolamine, di-isobutyl amine, ethylenediamine, N-formyl hexamethyleneimine, isopropyl amine, methylamine, propyl amine, pyridine, quinoline or triethylamine.

In an embodiment, the presently claimed invention is directed to a method of preparing a composition (C) comprising the steps of:
i. providing a solvent system; and
ii. adding at least one biocide to the solvent system (A) of step i. to obtain a mixture; wherein the solvent system (A) comprises:
(A1) a first component selected from an organic keto compound (A1a), an organic amine (A1b) or a combination thereof; and
(A2) a second component selected from an organic acid (A2a), an alcohol (A2b), an ester (A2c), an ether (A2d), or a combination thereof;
wherein Hansen solubility parameters of the first component are in the ranges of δ d 13-20 MPa^{1/2}, δ p 0.2-23 MPa^{1/2} and δ h 1-24 MPa^{1/2} and the Hansen solubility parameters of the second component (A2) are in the ranges of δ d 13-25 MPa^{1/2}, δ p 1-15 MPa^{1/2}, and δ h 2-30 MPa^{1/2},
wherein the mole ratio of total amount of A1 to the total amount of A2 is in the range of 1.0:5.0 to 5.0:1.0;
more preferably the method of preparing a composition (C) comprises the steps of:
   (i) providing a solvent system; and
   (ii) adding at least one biocide to the solvent system (A) of step i. to obtain a mixture;
wherein the solvent system (A) comprises:
(A1) a first component selected from an organic keto compound (A1a), an organic amine (A1b) or a combination thereof; and
(A2) a second component selected from an organic acid (A2a), an alcohol (A2b), an ester (A2c), an ether (A2d), or a combination thereof;
wherein Hansen solubility parameters of the first component are in the ranges of δ d 13-20 MPa^{1/2}, δ p 0.2-23 MPa^{1/2} and δ h 1-24 MPa^{1/2} and the Hansen solubility parameters of the second component (A2) are in the ranges of δ d 13-25 MPa^{1/2}, δ p 1-15 MPa^{1/2}, and δ h 2-30 MPa^{1/2},
wherein the mole ratio of total amount of A1 to the total amount of A2 is in the range of 1.0:3.0 to 3.0:1.0.

In an embodiment, the presently claimed invention is directed to a method of preparing a composition (C) comprising the steps of:
(i) providing a solvent system; and
(ii) adding at least one biocide to the solvent system (A) of step i. to obtain a mixture;
wherein the solvent system (A) comprises:
(A1) a first component, an organic keto compound (A1a); and
(A2) a second component selected from an organic acid (A2a), an alcohol (A2b), an ester (A2c), an ether (A2d), or a combination thereof;
wherein Hansen solubility parameters of the first component are in the ranges of δ d 13-20 MPa^{1/2}, δ p 0.2-23 MPa^{1/2} and δ h 1-24 MPa^{1/2} and the Hansen solubility parameters of the second component (A2) are in the ranges of δ d 13-25 MPa^{1/2}, δ p 1-15 MPa^{1/2}, and δ h 2-30 MPa^{1/2},
wherein the mole ratio of total amount of A1 to the total amount of A2 is in the range of 1.0:5.0 to 5.0:1.0, preferably 1.0:3.0 to 3.0:1.0, more preferably 1.0:2.0 to 2.0:1.0.
more preferably the method of preparing a composition (C) comprises the steps of:
   (i) providing a solvent system; and
   (ii) adding at least one biocide to the solvent system (A) of step i. to obtain a mixture;
wherein the solvent system (A) comprises:
(A1) a first component, an organic keto compound (A1a); and
(A2) a second component selected from an organic acid (A2a), an alcohol (A2b), an ester (A2c), an ether (A2d), or a combination thereof;
wherein Hansen solubility parameters of the first component are in the ranges of δ d 13-20 MPa^{1/2}, δ p 0.2-23 MPa^{1/2} and δ h 1-24 MPa^{1/2} and the Hansen solubility parameters of the second component (A2) are in the ranges of δ d 13-25 MPa^{1/2}, δ p 1-15 MPa^{1/2}, and δ h 2-30 MPa^{1/2},
wherein the mole ratio of total amount of A1 to the total amount of A2 is in the range of 1.0:3.0 to 3.0:1.0, preferably 1.0:3.0 to 3.0:1.0, more preferably 1.0:2.0 to 2.0:1.0.

In the above embodiment, the organic keto compound (A1a) is selected from acetophenone, benzophenone, n-butyl acetoacetate, cyclohexanone, methyl cyclohexanone, cyclodecanone, cycloheptanone, cyclooctaone, cyclopropylmethyl ketone, diethyl ketone, di-isobutyl ketone, dimethyldiketone, dipropylketone, ethyl butyl ketone, isophorone, pentoxone, methyl butyl ketone, methyl ethyl ketone, methyl isoamyl ketone, methyl isobutyl ketone, methyl isopropenyl ketone, methyl n-amyl ketone, or methyl n-propyl ketone, preferably, acetophenone, benzophenone, cyclohexanone, ethyl butyl ketone or methyl n-propyl ketone.

In another embodiment, the presently claimed invention is directed to a method of preparing a composition (C) comprising the steps of:
(i) providing a solvent system; and
(ii) adding at least one biocide to the solvent system (A) of step i. to obtain a mixture; wherein the solvent system (A) comprises:
(A1) a first component, an organic amine (A1b); and
(A2) a second component selected from an organic acid (A2a), an alcohol (A2b), an ester (A2c), an ether (A2d), or a combination thereof;
wherein Hansen solubility parameters of the first component are in the ranges of δ d 13-20 MPa^{1/2}, δ p 0.2-23 MPa^{1/2} and δ h 1-24 MPa^{1/2} and the Hansen solubility parameters of the second component (A2) are in the ranges of δ d 13-25 MPa^{1/2}, δ p 1-15 MPa^{1/2}, and δ h 2-30 MPa^{1/2},
wherein the mole ratio of total amount of A1 to the total amount of A2 is in the range of 1.0:5.0 to 5.0:1.0, preferably 1.0:3.0 to 3.0:1.0, more preferably 1.0:2.0 to 2.0:1.0.
more preferably the method of preparing a composition (C) comprises the steps of:
   (i) providing a solvent system; and
   (ii) adding at least one biocide to the solvent system (A) of step i. to obtain a mixture;
wherein the solvent system (A) comprises:
(A1) a first component, an organic amine (A1b); and
(A2) a second component selected from an organic acid (A2a), an alcohol (A2b), an ester (A2c), an ether (A2d), or a combination thereof;
wherein Hansen solubility parameters of the first component are in the ranges of δ d 13-20 MPa^{1/2}, δ p 0.2-23 MPa^{1/2} and δ h 1-24 MPa^{1/2} and the Hansen solubility parameters of the second component (A2) are in the ranges of δ d 13-25 MPa^{1/2}, δ p 1-15 MPa^{1/2}, and δ h 2-30 MPa^{1/2},
wherein the mole ratio of total amount of A1 to the total amount of A2 is in the range of 1.0:3.0 to 3.0:1.0, preferably 1.0:3.0 to 3.0:1.0, more preferably 1.0:2.0 to 2.0:1.0.

In the above embodiment, the organic amine compound (A1b) aniline, methoxy aniline, n-butyl amine, cyclohexylamine, di-2-ethylhexlamine, diethanolamine, di-isobutyl amine, ethylenediamine, N-formyl hexamethyleneimine, isopropyl amine, methylamine, propyl amine, pyridine, quinoline or triethylamine.

In an embodiment, the method further comprises:
(iii) heating the mixture obtained in step ii. to a temperature of 20° C. to 100° C. to obtain a heated mixture; and
(iv) adding at least one emulsifier (D) to the heated mixture obtained in step iii. to obtain the composition (C).

In another preferred embodiment, the composition (C) according to the presently claimed invention is an emulsifiable composition.

In another preferred embodiment, the at least one biocide is present in an amount of 5.0 to 85.0% by weight, based on the overall weight of the composition (C); more preferably the at least one biocide is present in an amount of 10.0 to 75.0% by weight, based on the overall weight of the composition (C), even more preferably the at least one biocide is present in an amount of 15.0 to 65.0% by weight, based on the overall weight of the composition (C); most preferably the at least one biocide is present in an amount of 15.0 to 55.0% by weight, based on the overall weight of the composition (C); and in particular preferably the at least one biocide is present in an amount of 15.0 to 45.0% by weight, based on the overall weight of the composition (C).

In an embodiment, the presently claimed invention is directed to an emulsion composition (E) comprising:
(a) a composition (C) in an amount in the range of 0.1 to 20.0% by weight, based on the overall weight of the emulsion composition (E); and
(b) water in an amount in the range of 60.0 to 99.9% by weight based on the overall weight of the composition (E);
   wherein the total amount of the composition (C) and water is in the range of 60.1 to 100% by weight based on the overall weight of the emulsion composition (E).

Yet another embodiment, the emulsion composition (E) comprising:
(a) a composition (C) in an amount in the range of 0.1 to 15.0% by weight, based on the overall weight of the emulsion composition (E); and
(b) water in an amount in the range of 70.0 to 99.9% by weight based on the overall weight of the composition (E);
   wherein the total amount of the composition (C) and water is in the range of 70.1 to 100% by weight based on the overall weight of the emulsion composition (E) more preferably the emulsion composition (E) comprising:
(a) a composition (C) in an amount in the range of 0.1 to 15.0% by weight, based on the overall weight of the emulsion composition (E); and
(b) water in an amount in the range of 75.0 to 99.9% by weight based on the overall weight of the composition (E);
   wherein the total amount of the composition (C) and water is in the range of 75.1 to 100% by weight based on the overall weight of the emulsion composition (E); most and in particular preferably the emulsion composition (E) comprising:
(a) a composition (C) in an amount in the range of 0.1 to 15.0% by weight, based on the overall weight of the emulsion composition (E); and
(b) water in an amount in the range of 80.0 to 99.9% by weight based on the overall weight of the composition (E);
   wherein the total amount of the composition (C) and water is in the range of 80.1 to 100% by weight based on the overall weight of the emulsion composition (E); and
   in particular and in particular preferably the emulsion composition (E) comprising:
(a) a composition (C) present in an amount in the range of 0.1 to 10.0% by weight, based on the overall weight of the emulsion composition (E); and
(b) water in an amount in the range of 90.0 to 99.9% by weight based on the overall weight of the composition (E);
   wherein the total amount of the composition (C) and water is in the range of 90.1 to 100% by weight based on the overall weight of the emulsion composition (E).

In an embodiment, the presently claimed invention is directed to a process for preparing an emulsion composition (E) comprising the steps of:
(i) providing a composition (C); and
(ii) adding water to the composition (C) of step i. to obtain an emulsion composition (E).

In an aspect, the presently claimed invention is directed to a use of the emulsion composition (E) for the treatment of soil and plants.

In another aspect, the presently claimed invention is directed to a method of treating soil and plants comprising the step of applying the emulsion composition (E) to the soil or plants.

In the following, there is provided a list of embodiments to further illustrate the present disclosure without intending to limit the disclosure to the specific embodiments listed below.

### Embodiments

1. A composition (C) comprising:
i) a solvent system (A) in an amount of 15.0 to 95.0% by weight, based on the overall weight of the composition; and
ii) at least one biocide (B) in an amount of 5.0 to 60.0% by weight, based on the overall weight of the composition;
wherein the total amount of the solvent system (A) and the at least one biocide (B) is in the range of 20.0 to 100% by weight based on the overall weight of the composition,
wherein the solvent system (A) comprises:
(A1) a first component selected from an organic keto compound (A1a), an organic amine (A1b) or a combination thereof; and
(A2) a second component selected from an organic acid (A2a), an alcohol (A2b), an ester (A2c), an ether (A2d), or a combination thereof;
wherein Hansen solubility parameters of the first component are in the ranges of δ d 13-20 MPa^{1/2}, δ p 0.2-23 MPa^{1/2} and δ h 1-24 MPa^{1/2} and Hansen solubility parameters of the second component are in the ranges of δ d 13-25 MPa^{1/2}, δ p 1-15 MPa^{1/2}, and δ h 2-30 MPa %,
wherein the mole ratio of total amount of A1 to the total amount of A2 is in the range of 1.0:5.0 to 5.0:1.0.

2. A composition (C) comprising:
i) a solvent system (A) in an amount of 15.0 to 95.0% by weight, based on the overall weight of the composition; and
ii) at least one biocide (B) in an amount of 5.0 to 60.0% by weight, based on the overall weight of the composition;
wherein the total amount of the solvent system (A) and the at least one biocide (B) is in the range of 20.0 to 100% by weight based on the overall weight of the composition,
wherein the solvent system (A) comprises:
(A1) a first component, an organic keto compound (A1a); and
(A2) a second component selected from an organic acid (A2a), an alcohol (A2b), an ester (A2c), an ether (A2d), or a combination thereof;
wherein Hansen solubility parameters of the first component are in the ranges of δ d 13-20 MPa^{1/2}, δ p 0.2-23 MPa^{1/2} and δ h 1-24 MPa^{1/2} and Hansen solubility parameters of the second component are in the ranges of δ d 13-25 MPa^{1/2}, δ p 1-15 MPa^{1/2}, and δ h 2-30 MPa^{1/2},
wherein the mole ratio of total amount of A1 to the total amount of A2 is in the range of 1.0:5.0 to 5.0:1.0.

3. A composition (C) comprising:
i) a solvent system (A) in an amount of 15.0 to 95.0% by weight, based on the overall weight of the composition; and
ii) at least one biocide (B) in an amount of 5.0 to 60.0% by weight, based on the overall weight of the composition;
wherein the total amount of the solvent system (A) and the at least one biocide (B) is in the range of 20.0 to 100% by weight based on the overall weight of the composition,
wherein the solvent system (A) comprises:
(A1) a first component, an organic amine (A1b); and
(A2) a second component selected from an organic acid (A2a), an alcohol (A2b), an ester (A2c), an ether (A2d), or a combination thereof;
wherein Hansen solubility parameters of the first component are in the ranges of δ d 13-20 MPa^{1/2}, δ p 0.2-23 MPa^{1/2} and δ h 1-24 MPa^{1/2} and Hansen solubility parameters of the second component are in the ranges of δ d 13-25 MPa^{1/2}, δ p 1-15 MPa^{1/2}, and δ h 2-30 MPa %,
wherein the mole ratio of total amount of A1 to the total amount of A2 is in the range of 1.0:5.0 to 5.0:1.0.

4. The composition (C) according to embodiment 1 to 3, wherein the composition (C) comprises
i) the solvent system (A) in an amount of 30.0 to 85.0% by weight, based on the overall weight of the composition; and
ii) the at least one biocide (B) in an amount of >10.0 to <50.0% by weight, based on the overall weight of the composition;
wherein the total amount of the solvent system (A) and the at least one biocide (B) is in the range of 40.0 to 100% by weight based on the overall weight of the composition,
wherein the solvent system (A) comprises:
(A1) the first component selected from an organic keto compound (A1a), an organic amine (A1b), or a combination thereof; and
(A2) the second component is selected from an organic acid (A2a), an alcohol (A2b), an ester (A2c), an ether (A2d), or a combination thereof;
wherein Hansen solubility parameters of the first component are in the ranges of δ d 13-20 MPa^{1/2}, δ p 0.2-23 MPa^{1/2} and δ h 1-24 MPa^{1/2} and the Hansen solubility parameters of the second component (A2) are in the ranges of δ d 13-25 MPa^{1/2}, δ p 1-15 MPa^{1/2}, and δ h 2-30 MPa^{1/2},
wherein the mole ratio of total amount of A1 to the total amount of A2 is in the range of 1.0:3.0 to 3.0:1.0.

5. The composition (C) according to any of the embodiments 1 to 4, wherein the Hansen solubility parameters of component (A1) are different from the Hansen solubility parameters of component (A2).

6. The composition (C) according to any of the embodiments 1 to 5, wherein the total amount of the first component (A1) and the second component (A2) is in the range of 60.0 to 100% by weight based on the overall weight of the solvent system.

7. The composition (C) according to any of the embodiments 1 to 6, wherein the at least one biocide (B) is selected from fungicide, insecticide, acaricide, rodenticide, nematicide, herbicide, or miticide.

8. The composition (C) according to any of the embodiments 1 to 7, wherein the organic keto compound (A1a) is selected from acetophenone, benzophenone, butadione, n-butyl acetoacetate, p-chloroacetophenone, chloroacetone, cyclohexanone, methyl cyclohexanone, cyclobutanone, cyclodecanone, cycloheptanone, cyclooctaone, cyclopentanone, cyclopropylmethyl ketone, diethyl ketone, di-isobutyl ketone, dimethyldiketone, dipropylketone, ethyl butyl ketone, ethyl vinyl ketone, ethylidene acetone, 4-fluoropropylphenone, isophorone, 4-methoxy acetophenone, pentoxone, methyl butyl ketone, 3-methyl cyclohexanone, 2-methyl cyclohexanone, methyl ethyl ketone, methyl isoamyl ketone, methyl isobutyl ketone, methyl isopropenyl ketone, methyl n-amyl ketone, methyl n-propyl ketone, methyl vinyl ketone, or 4-(trifluoromethyl) acetophenone.

9. The composition (C) according to any of the embodiments 1 to 8, wherein the organic amine (A1b) is selected from aniline, methoxy aniline, n-butyl amine, cyclohexylamine, di-2-ethylhexlamine, diallylamine, N,N-dichloroethylamine, diethanolamine, diethylamine, diethylenetriamine, di-isobutyl amine, dimethylamine, dimethylamine dimer, dipropyl amine, ethanolamine, ethylamine, ethylenediamine, ethyleneimine, N-formyl hexamethyleneimine, isopropyl amine, methylamine, propyl amine, pyridine, quinoline, triethanolamine, triethylamine, trimethyl amine, vinyl amine, or 4-vinyl pyridine.

10. The composition (C) according to any of the embodiments 1 to 9, wherein the organic acids (A2a) are selected from substituted or unsubstituted, linear or branched C₁-C₂₄ alkyl carboxylic acids, substituted or unsubstituted, linear or branched C₂-C₂₄ alkenyl carboxylic acids, substituted or unsubstituted C₅-C₂₄ cycloalkyl carboxylic acids, substituted or unsubstituted C₅-C₂₄ cycloalkenyl carboxylic acids, substituted or unsubstituted C₆-C₂₄ aryl carboxylic acids, or substituted or unsubstituted C₇-C₂₄ arylalkyl carboxylic acids.

11. The composition (C) according to any of the embodiments 1 to 10, wherein the organic acids (A2a) are selected from acetic acid, oxalic acid, trimethylglycine, citric acid, octanoic acid, nonanoic acid, dodecanoic acid, 2-furoic acid, maleic acid, pyruvic acid, lauric acid, glycolic acid, glutaric acid, malonic acid, succinic acid, terephthalic acid, oxalic acid, malic acid, fumaric acid, itaconic acid, acrylic acid, allyl acetic acid, butyric acid, crotonic acid, formic acid, D,L-lactic acid, 2-methyl acrylic acid, propionic acid, vinyl acetic acid, hydroxy pivalic acid, or phenyl acetic acid.

12. The composition (C) according to any of the embodiments 1 to 11, wherein the organic acids (A2a) are selected from acetic acid, formic acid, D,L-lactic acid, nonanoic acid, dodecanoic acid, hydroxy pivalic acid, or phenyl acetic acid.

13. The composition (C) according to any of the embodiments 1 to 12, wherein the organic alcohols (A2b) are selected from substituted or unsubstituted, linear or branched C₁-C₂₄ alkyl alcohols, substituted or unsubstituted, linear or branched C₂-C₂₄ alkenyl alcohols, substituted or unsubstituted C₅-C₂₄ cycloalkyl alcohols, substituted or unsubstituted C₅-C₂₄ cycloalkenyl alcohols, substituted or unsubstituted C₆-C₂₄ aryl alcohols, or substituted or unsubstituted C₇-C₂₄ arylalkyl alcohols.

14. The composition (C) according to any of the embodiments 1 to 13, wherein the organic alcohols (A2b) are selected from allyl alcohol, t-butyl cyclohexanol, xylitol, dextrose, 1,3-benzenediol, mannitol, benzyl alcohol, 2,3-butadiene-1-ol, 1,3-butanediol, 1,4-butanediol, t-butyl alcohol, 2-phenylethanol, thymol, 2-methoxy-4-methyl phenol, 2-sec-butyl phenol, 4-nitrophenol, 4-methyl cyclohexanol, butoxyethoxy propanol, 3-butoxy butanol, m-cresol, cyclohexanol, 2-cyclopentenyl alcohol, diacetone alcohol, 2-(diethyamino)ethanol, diethylene glycol, 2,6-dimethyl phenol, 3,4-dimethyl phenol, dipropylene glycol, dipropylene glycol methyl ether, ethanol, ethanolamine, 1-ethoxy-2-propanol, 2-ethyl-1-butanol, ethylene glycol, glycerol, hexylene glycol, 3-methyl-1-butanol, isobutyl alcohol, isooctyl alcohol, methanol, o-methoxyphenol, 3-methyl allyl alcohol, 2-methyl-1-butanol, 2-methyl-1-propanol, 2-methyl-2-butanol, 2-octanol, 1-pentanol, 2-pentanol, phenol, 2-phenoxy ethanol, 1-propanol, 2-propanol, propylene glycol, cuminol, triethanolamine, triethylene glycol, triethylene glycol monomethylether, 2-bromoallyl alcohol, 1,3-butanedol, 3-chloroallyl alcohol, 2-chloroallyl alcohol, 3-chloro-1-propanol, 4-chlorobnzyl alcohol, 2-chlorophenol, 1-decanol, 2-decanol, diisobutyl carbinol, 2-ethylhexanol, menthol, carvacrol, 2-ethyl phenol, o-methoxy, phenol, methyl isobutyl carbinol, or 4-isopropylbenzylmethanol.

15. The composition (C) according to any of the embodiments 1 to 14, wherein the organic alcohols (A2b) are selected from t-butyl cyclohexanol, xylitol, dextrose, mannitol, t-butyl alcohol, 2-phenylethanol, thymol, 2-methoxy-4-methyl phenol, 2-sec-butyl phenol, 4-nitrophenol, 4-methyl cyclohexanol, m-cresol, cyclohexanol, 2-cyclopentenyl alcohol, diethylene glycol, 2,6-dimethyl phenol, dipropylene glycol, dipropylene glycol methyl ether, ethanol, ethylene glycol, glycerol, hexylene glycol, isobutyl alcohol, isooctyl alcohol, methanol, o-methoxyphenol, phenol, 2-phenoxy ethanol, cuminol, triethylene glycol, triethylene glycol monomethylether, menthol, carvacrol, 2-ethyl phenol, o-methoxy, phenol, methyl isobutyl carbinol, or 4-isopropylbenzylmethanol.

16. The composition (C) according to any of the embodiments 1 to 15, wherein the organic ester (A2c) is selected from alkyl and aryl esters of substituted or unsubstituted, linear or branched C₁-C₂₄ alkyl carboxylic acid, alkyl and aryl esters of substituted or unsubstituted, linear or branched C₂-C₂₄ alkenyl carboxylic acid, alkyl and aryl esters of substituted or unsubstituted C₅-C₂₄ cycloalkyl carboxylic acid, alkyl and aryl esters of substituted or unsubstituted C₅-C₂₄ cycloalkenyl carboxylic acid, alkyl and aryl esters of substituted or unsubstituted C₆-C₂₄ aryl carboxylic acid, or alkyl and aryl esters of substituted or unsubstituted C₇-C₂₄ arylalkyl carboxylic acid.

17. The composition (C) according to any of the embodiments 1 to 16, wherein the organic ester (A2c) is selected from butyl lactate, n-butyl salicylate, ethyl lactate, methyl salicylate, or methyl benzoate.

18. The composition (C) according to any of the embodiments 1 to 17, wherein the organic ether (A2d) has C₅-C₃₀ carbon atoms.

19. The composition (C) according to any of the embodiments 1 to 18, wherein the organic ether (A2d) is selected from triethylene glycol monomethylether, p-methoxyaniline, diethylene glycol hexylether, diethylene glycol monobutylether, diethylene glycol monoethylether, diethylene glycol monomethylether, diethylene glycol monopropylether, 1,2-dimethoxy benzene, 4-methoxy acetophenone, ethylene glycol monobenzyl ether, ethylene glycol mono-t-butyl ether, ethylene glycol monobutyl ether, ethylene glycol monoethyl ether, allyl ethylether, allyl methylether, butenyl methyl ether, butyl isopropenyl ether, di-n-butyl ether, diphenyl ether, di(2-methoxyethyl)ether, diallyl ether, dibenzyl ether, diethylene glycol butyl ether acetate, diethylene glycol divinyl ether, diethylene glycol dibutyl ether, diethylene glycol methyl t-butyl ether, diethylene glycol diethyl ether, diethylene glycol hexyl ether, diethylene glycol monobutyl ether, diethylene glycol monoethyl ether, diethylene glycol monoethyl ether acetate, di propylene glycol monomethyl ether acetate, ethylene glycol butyl ether acetate, ethylene glycol butyl ethyl ether, ethylene glycol di-t-butyl ether, ethylene glycol dibutyl ether, ethylene glycol butyl methyl ether, ethylene glycol diethyl ether, ethylene glycol methyl t-butyl ether, ethylene glycol mono-2-ethyl hexyl ether, ethylene glycol monoethyl ether acrylate, ethylene glycol monoisobutyl ether, anisole, 4-ethoxy acetophenone, 4-methoxy acetophenone, 4-methoxy benzonitrile, nonyl phenoxy ethanol, or bis-(m-phenoxyphenyl) ether.

20. The composition (C) according to any of the embodiments 1 to 19, wherein the organic ether (A2d) is selected from 1,2-dimethoxy benzene, 4-methoxy acetophenone, dibenzyl ether, anisole, 4-ethoxy acetophenone, 4-methoxy benzonitrile, or bis-(m-phenoxyphenyl) ether.

21. The composition (C) according to any of the embodiments 1 to 20, wherein the organic acids (A2a) each have Hansen solubility parameters in the ranges δ d 13-25 MPa^{1/2}, δ p 3-15 MPa^{1/2} and δ h10-30 MPa^{1/2}.

22. The composition (C) according to any of the embodiments 1 to 21, wherein the organic alcohols (A2b) each have Hansen solubility parameters in the ranges δ d 14.0-20 MPa^{1/2}, δ p 4-12.5 MPa^{1/2} and δ h10-30 MPa^{1/2}.

23. The composition (C) according to any of the embodiments 1 to 22, wherein the organic ester (A2c) has Hansen solubility parameters in the ranges δ d 13-19 MPa^{1/2}, δ p 3-9 MPa^{1/2}, and δ h 3.5-14 MPa^{1/2}.

24. The composition (C) according to any of the embodiments 1 to 23, wherein the organic ether (A2d) has Hansen solubility parameters in the ranges δ d 14-20 MPa^{1/2}, δ p 3-12 MPa^{1/2}, and δ h 3-15 MPa^{1/2}.

25. The composition (C) according to any of the embodiments 1 to 24, wherein the organic keto compound (A1a) has Hansen solubility parameters in the ranges δ d 13.5-20 MPa^{1/2}, δ p 3.5-12.5 MPa^{1/2}, and δ h 3.5-7.0 MPa^{1/2}.

26. The composition (C) according to any of the embodiments 1 to 25, wherein the organic amine (A1b) has Hansen solubility parameters in the ranges δ d 14.5-20 MPa^{1/2}, δ p 0.8-15.5 MPa^{1/2}, and δ h 1.8-21.2 MPa^{1/2}.

27. The composition (C) according to any of the embodiments 1 to 26 further comprises at least one emulsifier (D) in an amount of 1.0 to 50.0% by weight, based on the overall weight of the composition (C).

28. The composition (C) according to embodiment 27, wherein the at least one emulsifier (D) is selected from anionic emulsifier and a non-ionic emulsifier.

29. The composition (C) according to any of the embodiments 1 to 28, wherein the composition has a viscosity in the range of 1 cp to 2000 cp at 25° C. at atmospheric pressure.

30. Use of a solvent system (A) for preparing an emulsifiable concentrate comprising at least one biocide (B), wherein the solvent system (A) comprises:
(A1) a first component selected from an organic keto compound (A1a), an organic amine (A1b) or a combination thereof; and
(A2) a second component selected from an organic acid (A2a), an alcohol (A2b), an ester (A2c), an ether (A2d), or a combination thereof;
wherein Hansen solubility parameters of the first component are in the ranges of δ d 13-20 MPa^{1/2}, δ p 0.2-23 MPa^{1/2} and δ h 1-24 MPa^{1/2} and the Hansen solubility parameters of the second component (A2) are in the ranges of δ d 13-25 MPa^{1/2}, δ p 1-15 MPa^{1/2}, and δ h 2-30 MPa^{1/2},
wherein the mole ratio of total amount of A1 to the total amount of A2 is in the range of 1.0:5.0 to 5.0:1.0.

31. Use of a solvent system (A) for preparing an emulsifiable concentrate comprising at least one biocide (B), wherein the solvent system (A) comprises:
(A1) a first component, an organic amine (A1b); and
(A2) a second component selected from an organic acid (A2a), an alcohol (A2b), an ester (A2c), an ether (A2d), or a combination thereof;
wherein Hansen solubility parameters of the first component are in the ranges of δ d 13-20 MPa^{1/2}, δ p 0.2-23 MPa^{1/2} and δ h 1-24 MPa^{1/2} and the Hansen solubility parameters of the second component (A2) are in the ranges of δ d 13-25 MPa^{1/2}, δ p 1-15 MPa^{1/2}, and δ h 2-30 MPa^{1/2},
wherein the mole ratio of total amount of A1 to the total amount of A2 is in the range of 1.0:5.0 to 5.0:1.0.

32. Use of a solvent system (A) for preparing an emulsifiable concentrate comprising at least one biocide (B), wherein the solvent system (A) comprises:
(A1) a first component, an organic amine (A1b); and
(A2) a second component selected from an organic acid (A2a), an alcohol (A2b), an ester (A2c), an ether (A2d), or a combination thereof;
wherein Hansen solubility parameters of the first component are in the ranges of δ d 13-20 MPa^{1/2}, δ p 0.2-23 MPa^{1/2} and δ h 1-24 MPa^{1/2} and the Hansen solubility parameters of the second component (A2) are in the ranges of δ d 13-25 MPa^{1/2}, δ p 1-15 MPa^{1/2}, and δ h 2-30 MPa^{1/2},
wherein the mole ratio of total amount of A1 to the total amount of A2 is in the range of 1.0:5.0 to 5.0:1.0.

33. The use according to embodiment 30 to 32, wherein the Hansen solubility parameters of component (A1) are different from the Hansen solubility parameters of component (A2).

34. The use according to any one of the embodiments 30 to 33, wherein the at least one biocide (B) is selected from fungicide, insecticide, acaricide, rodenticide, nematicide, herbicide, or miticide.

35. The use according to any of the embodiments 30 to 34, wherein the organic acids (A2a) are selected from substituted or unsubstituted, linear or branched C₁-C₂₄ alkyl carboxylic acids, substituted or unsubstituted, linear or branched C₂-C₂₄ alkenyl carboxylic acids, substituted or unsubstituted C₅-C₂₄ cycloalkyl carboxylic acids, substituted or unsubstituted C₅-C₂₄ cycloalkenyl carboxylic acids, substituted or unsubstituted C₆-C₂₄ aryl carboxylic acids, or substituted or unsubstituted C₇-C₂₄ arylalkyl carboxylic acids.

36. The use according to any of the embodiments 30 to 35, wherein the organic acids (A2a) are selected from acetic acid, oxalic acid, trimethylglycine, citric acid, octanoic acid, nonanoic acid, dodecanoic acid, 2-furoic acid, maleic acid, pyruvic acid, lauric acid, glycolic acid, glutaric acid, malonic acid, succinic acid, terephthalic acid, oxalic acid, malic acid, fumaric acid, itaconic acid, acrylic acid, allyl acetic acid, butyric acid, crotonic acid, formic acid, D,L-lactic acid, 2-methyl acrylic acid, propionic acid, vinyl acetic acid, hydroxy pivalic acid, or phenyl acetic acid.

37. The use according to any of the embodiments 30 to 36, wherein the organic acids (A2a) are selected from acetic acid, formic acid, D,L-lactic acid, nonanoic acid, dodecanoic acid, hydroxy pivalic acid, or phenyl acetic acid.

38. The use according to any of the embodiments 30 to 37, wherein the organic alcohols (A2b) are selected from substituted or unsubstituted, linear or branched C₁-C₂₄ alkyl alcohols, substituted or unsubstituted, linear or branched C₂-C₂₄ alkenyl alcohols, substituted or unsubstituted C₅-C₂₄ cycloalkyl alcohols, substituted or unsubstituted C₅-C₂₄ cycloalkenyl alcohols, substituted or unsubstituted C₆-C₂₄ aryl alcohols, or substituted or unsubstituted C₇-C₂₄ arylalkyl alcohols.

39. The use according to any of the embodiments 30 to 38, wherein the organic alcohols (A2b) are selected from allyl alcohol, t-butyl cyclohexanol, xylitol, dextrose, 1,3-benzenediol, mannitol, benzyl alcohol, 2,3-butadiene-1-ol, 1,3-butanediol, 1,4-butanediol, t-butyl alcohol, 2-phenylethanol, thymol, 2-methoxy-4-methyl phenol, 2-sec-butyl phenol, 4-nitrophenol, 4-methyl cyclohexanol, butoxyethoxy propanol, 3-butoxy butanol, m-cresol, cyclohexanol, 2-cyclopentenyl alcohol, diacetone alcohol, 2-(diethyamino)ethanol, diethylene glycol, 2,6-dimethyl phenol, 3,4-dimethyl phenol, dipropylene glycol, dipropylene glycol methyl ether, ethanol, ethanolamine, 1-ethoxy-2-propanol, 2-ethyl-1-butanol, ethylene glycol, glycerol, hexylene glycol, 3-methyl-1-butanol, isobutyl alcohol, isooctyl alcohol, methanol, o-methoxyphenol, 3-methyl allyl alcohol, 2-methyl-1-butanol, 2-methyl-1-propanol, 2-methyl-2-butanol, 2-octanol, 1-pentanol, 2-pentanol, phenol, 2-phenoxy ethanol, 1-propanol, 2-propanol, propylene glycol, cuminol, triethanolamine, triethylene glycol, triethylene glycol monomethylether, 2-bromoallyl alcohol, 1,3-butanedol, 3-chloroallyl alcohol, 2-chloroallyl alcohol, 3-chloro-1-propanol, 4-chlorobnzyl alcohol, 2-chlorophenol, 1-decanol, 2-decanol, diisobutyl carbinol, 2-ethylhexanol, menthol, carvacrol, 2-ethyl phenol, o-methoxy, phenol, methyl isobutyl carbinol, or 4-isopropylbenzylmethanol.

40. The use according to any of the embodiments 30 to 39, wherein the organic alcohols (A2b) are selected from t-butyl cyclohexanol, xylitol, dextrose, mannitol, t-butyl alcohol, 2-phenylethanol, thymol, 2-methoxy-4-methyl phenol, 2-sec-butyl phenol, 4-nitrophenol, 4-methyl cyclohexanol, m-cresol, cyclohexanol, 2-cyclopentenyl alcohol, diethylene glycol, 2,6-dimethyl phenol, dipropylene glycol, dipropylene glycol methyl ether, ethanol, ethylene glycol, glycerol, hexylene glycol, isobutyl alcohol, isooctyl alcohol, methanol, o-methoxyphenol, phenol, 2-phenoxy ethanol, cuminol, triethylene glycol, triethylene glycol monomethylether, menthol, carvacrol, 2-ethyl phenol, o-methoxy, phenol, methyl isobutyl carbinol, or 4-isopropylbenzylmethanol.

41. The use according to any of the embodiments 30 to 40, wherein the organic ester (A2c) is selected from alkyl and aryl esters of substituted or unsubstituted, linear or branched C₁-C₂₄ alkyl carboxylic acid, alkyl and aryl esters of substituted or unsubstituted, linear or branched C₂-C₂₄ alkenyl carboxylic acid, alkyl and aryl esters of substituted or unsubstituted C₅-C₂₄ cycloalkyl carboxylic acid, alkyl and aryl esters of substituted or unsubstituted C₅-C₂₄ cycloalkenyl carboxylic acid, alkyl and aryl esters of substituted or unsubstituted C₆-C₂₄ aryl carboxylic acid, and alkyl, or aryl esters of substituted or unsubstituted C₇-C₂₄ arylalkyl carboxylic acid.

42. The use according to any of the embodiments 30 to 41, wherein the organic ester (A2c) is selected from butyl lactate, n-butyl salicylate, ethyl lactate, methyl salicylate, or methyl benzoate.

43. The use according to any of the embodiments 30 to 42, wherein the organic ether (A2d) is ether moieties having C₅-C₃₀ carbon atoms.

44. The use according to any of the embodiments 30 to 43, wherein the organic ether (A2d) is selected from triethylene glycol monomethylether, p-methoxyaniline, diethylene glycol hexylether, diethylene glycol monobutylether, diethylene glycol monoethylether, diethylene glycol monomethylether, diethylene glycol monopropylether, 1,2-dimethoxy benzene, 4-methoxy acetophenone, ethylene glycol monobenzyl ether, ethylene glycol mono-t-butyl ether, ethylene glycol monobutyl ether, ethylene glycol monoethyl ether, allyl ethylether, allyl methylether, butenyl methyl ether, butyl isopropenyl ether, di-n-butyl ether, diphenyl ether, di(2-methoxyethyl)ether, diallyl ether, dibenzyl ether, diethylene glycol butyl ether acetate, diethylene glycol divinyl ether, diethylene glycol dibutyl ether, diethylene glycol methyl t-butyl ether, diethylene glycol diethyl ether, diethylene glycol hexyl ether, diethylene glycol monobutyl ether, diethylene glycol monoethyl ether, diethylene glycol monoethyl ether acetate, di propylene glycol monomethyl ether acetate, ethylene glycol butyl ether acetate, ethylene glycol butyl ethyl ether, ethylene glycol di-t-butyl ether, ethylene glycol dibutyl ether, ethylene glycol butyl methyl ether, ethylene glycol diethyl ether, ethylene glycol methyl t-butyl ether, ethylene glycol mono-2-ethyl hexyl ether, ethylene glycol monoethyl ether acrylate, ethylene glycol monoisobutyl ether, anisole, 4-ethoxy acetophenone, 4-methoxy acetophenone, 4-methoxy benzonitrile, nonyl phenoxy ethanol, or bis-(m-phenoxyphenyl) ether.

45. The use according to any of the embodiments 30 to 44, wherein the organic ether (A2d) is selected from 1,2-dimethoxy benzene, 4-methoxy acetophenone, dibenzyl ether, anisole, 4-ethoxy acetophenone, 4-methoxy benzonitrile, or bis-(m-phenoxyphenyl) ether.

46. The use according to any of the embodiments 30 to 45, wherein the organic keto compound (A1a) is selected from acetophenone, benzophenone, butadione, n-butyl acetoacetate, p-chloroacetophenone, chloroacetone, cyclohexanone, methyl cyclohexanone, cyclobutanone, cyclodecanone, cycloheptanone, cyclooctaone, cyclopentanone, cyclopropylmethyl ketone, diethyl ketone, di-isobutyl ketone, dimethyldiketone, dipropylketone, ethyl butyl ketone, ethyl vinyl ketone, ethylidene acetone, 4-fluoropropylphenone, isophorone, 4-methoxy acetophenone, pentoxone, methyl butyl ketone, 3-methyl cyclohexanone, 2-methyl cyclohexanone, methyl ethyl ketone, methyl isoamyl ketone, methyl isobutyl ketone, methyl isopropenyl ketone, methyl n-amyl ketone, methyl n-propyl ketone, methyl vinyl ketone, or 4-(trifluoromethyl)acetophenone.

47. The use according to any of the embodiments 30 to 46, wherein the organic amine (A1b) is selected from aniline, methoxy aniline, n-butyl amine, cyclohexylamine, di-2-ethylhexlamine, diallylamine, N,N-dichloroethylamine, diethanolamine, diethylamine, diethylenetriamine, di-isobutyl amine, dimethylamine, dimethylamine dimer, dipropyl amine, ethanolamine, ethylamine, ethylenediamine, ethyleneimine, N-formyl hexamethyleneimine, isopropyl amine, methylamine, propyl amine, pyridine, quinoline, triethanolamine, triethylamine, trimethyl amine, vinyl amine, or 4-vinyl pyridine.

48. The use according to any of the embodiments 30 to 47, wherein the organic acids (A2a) have Hansen solubility parameters in the ranges δ d 13-25 MPa^{1/2}, δ p 3-15 MPa^{1/2} and δ h10-30 MPa^{1/2}.

49. The use according to any of the embodiments 30 to 48, wherein the organic alcohols (A2b) have Hansen solubility parameters in the ranges δ d 14-20 MPa^{1/2}, δ p 4-12.5 MPa^{1/2} and δ h10-30 MPa^{1/2}.

50. The use according to any of the embodiments 30 to 49, wherein the organic ester (A2c) has Hansen solubility parameters in the ranges δ d 13-19 MPa^{1/2}, δ p 3-9 MPa^{1/2}, and δ h 3.5-14 MPa^{1/2}.

51. The use according to any of the embodiments 30 to 50, wherein the organic ether (A2d) has Hansen solubility parameters in the ranges δ d 14-20 MPa^{1/2}, δ p 3-12 MPa^{1/2}, and δ h 3-15 MPa^{1/2}.

52. The use according to any of the embodiments 30 to 51, wherein composition (C) further comprises at least one emulsifier (D) in an amount of 1.0 to 50.0% by weight, based on the overall weight of the composition (C).

53. The use according to any of the embodiments 30 to 52, wherein the at least one emulsifier (D) is selected from anionic emulsifier and a non-ionic emulsifier.

54. A method of preparing a composition (C) comprising the steps of:
i. providing a solvent system; and
ii. adding at least one biocide (B) to the solvent system (A) of step i. to obtain a mixture;
wherein the solvent system (A) comprises:
   (A1) a first component selected from an organic keto compound (A1a), an organic amine (A1b) or a combination thereof; and
(A2) a second component selected from an organic acid (A2a), an alcohol (A2b), an ester (A2c), an ether (A2d), or a combination thereof;
wherein Hansen solubility parameters of the first component are in the ranges of δ d 13-20 MPa^{1/2}, δ p 0.2-23 MPa^{1/2} and δ h 1-24 MPa^{1/2} and the Hansen solubility parameters of the second component (A2) are in the ranges of δ d 13-25 MPa^{1/2}, δ p 1-15 MPa^{1/2}, and δ h 2-30 MPa^{1/2},
wherein the mole ratio of total amount of A1 to the total amount of A2 is in the range of 1.0:5.0 to 5.0:1.0.

55. A method of preparing a composition (C) comprising the steps of:
i. providing a solvent system; and
ii. adding at least one biocide (B) to the solvent system (A) of step i. to obtain a mixture;
wherein the solvent system (A) comprises:
   (A1) a first component, organic keto compound (A1a); and
(A2) a second component selected from an organic acid (A2a), an alcohol (A2b), an ester (A2c), an ether (A2d), or a combination thereof;
wherein Hansen solubility parameters of the first component are in the ranges of δ d 13-20 MPa^{1/2}, δ p 0.2-23 MPa^{1/2} and δ h 1-24 MPa^{1/2} and the Hansen solubility parameters of the second component (A2) are in the ranges of δ d 13-25 MPa^{1/2}, δ p 1-15 MPa^{1/2}, and δ h 2-30 MPa^{1/2},
wherein the mole ratio of total amount of A1 to the total amount of A2 is in the range of 1.0:5.0 to 5.0:1.0.

56. A method of preparing a composition (C) comprising the steps of:
i. providing a solvent system; and
ii. adding at least one biocide (B) to the solvent system (A) of step i. to obtain a mixture;
wherein the solvent system (A) comprises:
   (A1) a first component, an organic amine (A1b); and
(A2) a second component selected from an organic acid (A2a), an alcohol (A2b), an ester (A2c), an ether (A2d), or a combination thereof;
wherein Hansen solubility parameters of the first component are in the ranges of δ d 13-20 MPa^{1/2}, δ p 0.2-23 MPa^{1/2} and δ h 1-24 MPa^{1/2} and the Hansen solubility parameters of the second component (A2) are in the ranges of δ d 13-25 MPa^{1/2}, δ p 1-15 MPa^{1/2}, and δ h 2-30 MPa^{1/2},
wherein the mole ratio of total amount of A1 to the total amount of A2 is in the range of 1.0:5.0 to 5.0:1.0. 57. The method according to embodiment 54 to 56, wherein the Hansen solubility parameters of component (A1) are different from the Hansen solubility parameters of component (A2).

58. The method according to any one of the embodiments 54 to 57 further comprises:
iii. heating the mixture obtained in step ii. to a temperature of 20° C. to 100° C. to obtain a heated mixture; and
iv. adding at least one emulsifier (D) to the heated mixture obtained in step iii. to obtain the composition (C).

59. The method according any of the embodiments 54 to 58, wherein the total amount of the solvent system (A) is in the range of 60.0 to 100% by weight based on the overall weight of the composition (C).

60. The method according to any of the embodiments 54 to 59, wherein the solvent system (A) is present in an amount of 15.0 to 85.0% by weight, based on the overall weight of the composition (C).

61. The method according to the embodiments 54 to 60, wherein the at least one biocide is present in an amount of 15.0 to 85.0% by weight, based on the overall weight of the composition (C).

62. The method according to any of the embodiments 54 to 61, wherein the at least one biocide (B) is selected from fungicide, insecticide, acaricide, rodenticide, nematicide, herbicide, or miticide.

63. The method according to any of the embodiments 54 to 62, wherein the organic keto compound (A1a) is selected from acetophenone, benzophenone, butadione, n-butyl acetoacetate, p-chloroacetophenone, chloroacetone, cyclohexanone, methyl cyclohexanone, cyclobutanone, cyclodecanone, cycloheptanone, cyclooctaone, cyclopentanone, cyclopropylmethyl ketone, diethyl ketone, di-isobutyl ketone, dimethyldiketone, dipropylketone, ethyl butyl ketone, ethyl vinyl ketone, ethylidene acetone, 4-fluoropropylphenone, isophorone, 4-methoxy acetophenone, pentoxone, methyl butyl ketone, 3-methyl cyclohexanone, 2-methyl cyclohexanone, methyl ethyl ketone, methyl isoamyl ketone, methyl isobutyl ketone, methyl isopropenyl ketone, methyl n-amyl ketone, methyl n-propyl ketone, methyl vinyl ketone, or 4-(trifluoromethyl) acetophenone.

64. The method according to any of the embodiments 54 to 63, wherein the organic amine (A1b) is selected from aniline, methoxy aniline, n-butyl amine, cyclohexylamine, di-2-ethylhexlamine, diallylamine, N,N-dichloroethylamine, diethanolamine, diethylamine, diethylenetriamine, di-isobutyl amine, dimethylamine, dimethylamine dimer, dipropyl amine, ethanolamine, ethylamine, ethylenediamine, ethyleneimine, N-formyl hexamethyleneimine, isopropyl amine, methylamine, propyl amine, pyridine, quinoline, triethanolamine, triethylamine, trimethyl amine, vinyl amine, or 4-vinyl pyridine.

65. The method according to any of the embodiments 54 to 64, wherein the organic acids (A2a) are selected from substituted or unsubstituted, linear or branched C₁-C₂₄ alkyl carboxylic acids, substituted or unsubstituted, linear or branched C₂-C₂₄ alkenyl carboxylic acid, substituted or unsubstituted C₅-C₂₄ cycloalkyl carboxylic acid, substituted or unsubstituted C₅-C₂₄ cycloalkenyl carboxylic acid, substituted or unsubstituted C₆-C₂₄ aryl carboxylic acid, or substituted or unsubstituted C₇-C₂₄ arylalkyl carboxylic acid.

66. The method according to any of the embodiments 54 to 65, wherein the organic acids (A2a) are selected from acetic acid, oxalic acid, trimethylglycine, citric acid, octanoic acid, nonanoic acid, dodecanoic acid, 2-furoic acid, maleic acid, pyruvic acid, lauric acid, glycolic acid, glutaric acid, malonic acid, succinic acid, terephthalic acid, oxalic acid, malic acid, fumaric acid, itaconic acid, acrylic acid, allyl acetic acid, butyric acid, crotonic acid, formic acid, D,L-lactic acid, 2-methyl acrylic acid, propionic acid, vinyl acetic acid, hydroxy pivalic acid, or phenyl acetic acid.

67. The method according to any of the embodiments 54 to 66, wherein the organic acids (A2a) are selected from acetic acid, formic acid, D,L-lactic acid, nonanoic acid, dodecanoic acid, hydroxy pivalic acid, or phenyl acetic acid.

68. The method according to any of the embodiments 54 to 67, wherein the organic alcohols (A2b) are selected from substituted or unsubstituted, linear or branched C₁-C₂₄ alkyl alcohols, substituted or unsubstituted, linear or branched C₂-C₂₄ alkenyl alcohols, substituted or unsubstituted C₅-C₂₄ cycloalkyl alcohols, substituted or unsubstituted C₅-C₂₄ cycloalkenyl alcohols, substituted or unsubstituted C₆-C₂₄ aryl alcohols, or substituted or unsubstituted C₇-C₂₄ arylalkyl alcohols.

69. The method according to any of the embodiments 54 to 68, wherein the organic alcohols (A2b) are selected from allyl alcohol, t-butyl cyclohexanol, xylitol, dextrose, 1,3-benzenediol, mannitol, benzyl alcohol, 2,3-butadiene-1-ol, 1,3-butanediol, 1,4-butanediol, t-butyl alcohol, 2-phenylethanol, thymol, 2-methoxy-4-methyl phenol, 2-sec-butyl phenol, 4-nitrophenol, 4-methyl cyclohexanol, butoxyethoxy propanol, 3-butoxy butanol, m-cresol, cyclohexanol, 2-cyclopentenyl alcohol, diacetone alcohol, 2-(diethyamino)ethanol, diethylene glycol, 2,6-dimethyl phenol, 3,4-dimethyl phenol, dipropylene glycol, dipropylene glycol methyl ether, ethanol, ethanolamine, 1-ethoxy-2-propanol, 2-ethyl-1-butanol, ethylene glycol, glycerol, hexylene glycol, 3-methyl-1-butanol, isobutyl alcohol, isooctyl alcohol, methanol, o-methoxyphenol, 3-methyl allyl alcohol, 2-methyl-1-butanol, 2-methyl-1-propanol, 2-methyl-2-butanol, 2-octanol, 1-pentanol, 2-pentanol, phenol, 2-phenoxy ethanol, 1-propanol, 2-propanol, propylene glycol, cuminol, triethanolamine, triethylene glycol, triethylene glycol monomethylether, 2-bromoallyl alcohol, 1,3-butanedol, 3-chloroallyl alcohol, 2-chloroallyl alcohol, 3-chloro-1-propanol, 4-chlorobnzyl alcohol, 2-chlorophenol, 1-decanol, 2-decanol, diisobutyl carbinol, 2-ethylhexanol, menthol, carvacrol, 2-ethyl phenol, o-methoxy, phenol, methyl isobutyl carbinol, or 4-isopropylbenzylmethanol.

70. The method according to any of the embodiments 54 to 69, wherein the organic alcohols (A2b) are selected from t-butyl cyclohexanol, xylitol, dextrose, mannitol, t-butyl alcohol, 2-phenylethanol, thymol, 2-methoxy-4-methyl phenol, 2-sec-butyl phenol, 4-nitrophenol, 4-methyl cyclohexanol, m-cresol, cyclohexanol, 2-cyclopentenyl alcohol, diethylene glycol, 2,6-dimethyl phenol, dipropylene glycol, dipropylene glycol methyl ether, ethanol, ethylene glycol, glycerol, hexylene glycol, isobutyl alcohol, isooctyl alcohol, methanol, o-methoxyphenol, phenol, 2-phenoxy ethanol, cuminol, triethylene glycol, triethylene glycol monomethylether, menthol, carvacrol, 2-ethyl phenol, o-methoxy, phenol, methyl isobutyl carbinol, or 4-isopropylbenzylmethanol.

71. The method according to any of the embodiments 54 to 70, wherein the organic ester (A2c) is selected from alkyl and aryl esters of substituted or unsubstituted, linear or branched C₁-C₂₄ alkyl carboxylic acid, alkyl and aryl esters of substituted or unsubstituted, linear or branched C₂-C₂₄ alkenyl carboxylic acid, alkyl and aryl esters of substituted or unsubstituted C₅-C₂₄ cycloalkyl carboxylic acid, alkyl and aryl esters of substituted or unsubstituted C₅-C₂₄ cycloalkenyl carboxylic acid, alkyl and aryl esters of substituted or unsubstituted C₆-C₂₄ aryl carboxylic acid, or alkyl, and aryl esters of substituted or unsubstituted C₇-C₂₄ arylalkyl carboxylic acid.

72. The method according to any of the embodiments 54 to 71, wherein the organic ester (A2c) is selected from butyl lactate, n-butyl salicylate, ethyl lactate, methyl salicylate, or methyl benzoate.

73. The method according to any of the embodiments 54 to 72, wherein the organic ether (A2d) has C₅-C₃₀ carbon atoms.

74. The method according to any of the embodiments 54 to 73, wherein the organic ether (A2d) is selected from triethylene glycol monomethylether, p-methoxyaniline, diethylene glycol hexylether, diethylene glycol monobutylether, diethylene glycol monoethylether, diethylene glycol monomethylether, diethylene glycol monopropylether, 1,2-dimethoxy benzene, 4-methoxy acetophenone, ethylene glycol monobenzyl ether, ethylene glycol mono-t-butyl ether, ethylene glycol monobutyl ether, ethylene glycol monoethyl ether, allyl ethylether, allyl methylether, butenyl methyl ether, butyl isopropenyl ether, di-n-butyl ether, diphenyl ether, di(2-methoxyethyl)ether, diallyl ether, dibenzyl ether, diethylene glycol butyl ether acetate, diethylene glycol divinyl ether, diethylene glycol dibutyl ether, diethylene glycol methyl t-butyl ether, diethylene glycol diethyl ether, diethylene glycol hexyl ether, diethylene glycol monobutyl ether, diethylene glycol monoethyl ether, diethylene glycol monoethyl ether acetate, di propylene glycol monomethyl ether acetate, ethylene glycol butyl ether acetate, ethylene glycol butyl ethyl ether, ethylene glycol di-t-butyl ether, ethylene glycol dibutyl ether, ethylene glycol butyl methyl ether, ethylene glycol diethyl ether, ethylene glycol methyl t-butyl ether, ethylene glycol mono-2-ethyl hexyl ether, ethylene glycol monoethyl ether acrylate, ethylene glycol monoisobutyl ether, anisole, 4-ethoxy acetophenone, 4-methoxy acetophenone, 4-methoxy benzonitrile, nonyl phenoxy ethanol, or bis-(m-phenoxyphenyl) ether.

75. The method according to any of the embodiments 54 to 74, wherein the organic ether (A2d) is selected from 1,2-dimethoxy benzene, 4-methoxy acetophenone, dibenzyl ether, anisole, 4-ethoxy acetophenone, 4-methoxy benzonitrile, or bis-(m-phenoxyphenyl) ether.

76. The method according to any of the embodiments 54 to 75, wherein the organic acids (A2a) each have Hansen solubility parameters in the ranges δ d 13-25 MPa^{1/2}, δ p 3-15 MPa^{1/2} and δ h10-30 MPa^{1/2}.

77. The method according to any of the embodiments 54 to 76, wherein the organic alcohols (A2b) each have Hansen solubility parameters in the ranges δ d 14-20 MPa^{1/2}, δ p 4-12.5 MPa^{1/2} and δ h10-30 MPa^{1/2}.

78. The method according to any of the embodiments 54 to 77, wherein the organic ester (A2c) has Hansen solubility parameters in the ranges δ d 13-19 MPa^{1/2}, δ p 3-9 MPa^{1/2}, and δ h 3.5-14 MPa^{1/2}.

79. The method according to any of the embodiments 54 to 78, wherein the organic ether (A2d) has Hansen solubility parameters in the ranges δ d 14-20 MPa^{1/2}, δ p 3-12 MPa^{1/2}, and δ h 3-15 MPa^{1/2}.

80. An emulsion composition (E) comprising:
a. a composition (C) according to any of the embodiments 1 to 29 in an amount in the range of 0.1 to 20.0% by weight, based on the overall weight of the emulsion composition (E); and
b. water in an amount in the range of 60.0 to 99.9% by weight based on the overall weight of the composition (E);
wherein the total amount of the composition (C) and water is in the range of 61.1 to 100% by weight based on the overall weight of the emulsion composition (E).

81. A process for preparing an emulsion composition (E) according to the embodiment 74 comprising the steps of:
i. providing a composition (C) according to any of the embodiments 1 to 29; and
ii. adding water to the composition (C) of step i. to obtain an emulsion composition (E).

82. Use of the emulsion composition (E) according to the embodiment 80 for the treatment of soil and plants.

83. A method of treating soil and plants comprising the step of applying the emulsion composition (E) according to the embodiment 80 to the soil or plants.

While the presently claimed invention has been described in terms of its specific embodiments, certain modifications and equivalents will be apparent to those skilled in the art and are intended to be included within the scope of the presently claimed invention.

### Examples

The presently claimed invention is illustrated in detail by non-restrictive working examples which follow. More particularly, the test methods specified hereinafter are part of the general disclosure of the application and are not restricted to the specific working examples.

Methods and materials: menthol, acetic acid, cyclohexanol, D,L-Lactic acid, formic acid, hydroxy pivalic acid, methyl salicylate, 4-methylcyclohexanol, 2-phenylethanol, phenyl acetic acid, thymol,1,2-dimethoxy benzene, 4-methoxy acetophenone, 4-isopropylbenzylalcohol, anisole, and 2-phenoxyethanol are commercially available from VWR, Sigma Aldrich and and/or BASF corporation.

Azoxystrobin is available from Taizhou Bailly Chemical Company, LTD.

Tebuconazole is available from Parchem Fine and Specialty Chemicals.

Sulfentrazone is available from Willowood.

Agnique AMD 10 is C10 fatty acid dimethylamide and is available from BASF corporation.

Aromatic 200 ND is naphtha (petroleum), heavy aromatic-naphtahlene depleted and is available from Exxon.

Agnique CSO-36 is ethoxylated Castor Oil (POE 36) and is available from BASF corporation.

Ninate 401-A is calcium alkylbenzene sulfonate and is available from Stepan Company.

General method of preparing emulsifiable composition (C): Component (A1) and component (A2) were mixed and heated to a temperature in the range of 20° C. to 100° C. to obtain a solution. Respective amount of the biocide was charged to the above solution at a temperature in the range of 20° C. to 100° C. to obtain the solution containing biocide. Emulsifier and other optional ingredients were charged o to the above biocide containing solution to obtain the emulsifiable composition (C).

### Method for the Preparation of Emulsion:

The emulsion was prepared by mixing 0.1 to 20.0% by weight of emulsifiable composition (C) obtained above, in water.

TABLE 1
Solubility of Biocide in solvent system:

| Solvent system | | Molar | Solubility wt. % |
|---|---|---|---|
| Component | Component | ratio | in total (C) |
| (A1) | (A2) | (A1:A2) | Azoxystrobin |
| Acetophenone | Phenyl acetic acid | 2:1 | 25 |
| Acetophenone | Thymol | 1:1 | 28 |
| Acetophenone | 2-Methoxy-4-Methylphenol | 1:1 | 27 |
| Acetophenone | 2-sec-Butylphenol | 1:1 | 32 |

It is evident from table 1 that the azoxystrobin can be solubilized in a solvent system to obtain an emulsifiable concentrate compared to the known solvent system which provides a suspension concentrate. The emulsifiable concentrate can be formed into water emulsion which avoids the problem associated with suspension concentrate such as crystallization of the biocide.

1. A composition (C) comprising:
i) a solvent system (A) in an amount of from 15.0 to 95.0% by weight, based on the overall weight of the composition; and
ii) at least one biocide (B) in an amount of from 5.0 to 60.0% by weight, based on the overall weight of the composition;
wherein the total amount of the solvent system (A) and the at least one biocide (B) is in the range of from 20.0 to 100% by weight based on the overall weight of the composition (C),
wherein the solvent system (A) comprises:
(A1) a first component selected from the group consisting of an organic keto compound (A1a), an organic amine (A1b), and a combination thereof; and
(A2) a second component selected from the group consisting of an organic acid (A2a), an alcohol (A2b), an ester (A2c), an ether (A2d), and a combination of two or more thereof;
wherein Hansen solubility parameters of the first component (A1) are in the ranges of δ d 13-20 MPa^{1/2}, δp 0.2-23 MPa^{1/2} and δh 1-24 MPa¹² and Hansen solubility parameters of the second component (A2) are in the ranges of δd 13-25 MPa^{1/2}, δp 1-15 MPa^{1/2}, and δh 2-30 MPa^{1/2},
wherein the mole ratio of total amount of A1 to the total amount of A2 is in the range of from 1.0:5.0 to 5.0:1.0.

2. (canceled)

3. (canceled)

4. The composition (C) according to claim 1, wherein the at least one biocide (B) is selected from the group consisting of fungicide, insecticide, acaricide, rodenticide, nematicide, herbicide, and miticide.

5. The composition (C) according to claim 1, wherein the Hansen solubility parameters of component (A1) are different from the Hansen solubility parameters of component (A2).

6. The composition (C) according to claim 1, wherein the organic keto compound (A1a) is selected from the group consisting of acetophenone, benzophenone, butadione, n-butyl acetoacetate, p-chloroacetophenone, chloroacetone, cyclohexanone, methyl cyclohexanone, cyclobutanone, cyclodecanone, cycloheptanone, cyclooctaone, cyclopentanone, cyclopropylmethyl ketone, diethyl ketone, di-isobutyl ketone, dimethyldiketone, dipropylketone, ethyl butyl ketone, ethyl vinyl ketone, ethylidene acetone, 4-fluoropropylphenone, isophorone, 4-methoxy acetophenone, pentoxone, methyl butyl ketone, 3-methyl cyclohexanone, 2-methyl cyclohexanone, methyl ethyl ketone, methyl isoamyl ketone, methyl isobutyl ketone, methyl isopropenyl ketone, methyl n-amyl ketone, methyl n-propyl ketone, methyl vinyl ketone, and 4-(trifluoromethyl)acetophenone.

7. The composition (C) according to claim 1, wherein the organic amine (A1b) is selected from the group consisting of aniline, methoxy aniline, n-butyl amine, cyclohexylamine, di-2-ethylhexlamine, diallylamine, N,N-dichloroethylamine, diethanolamine, diethylamine, diethylenetriamine, di-isobutyl amine, dimethylamine, dimethylamine dimer, dipropyl amine, ethanolamine, ethylamine, ethylenediamine, ethyleneimine, N-formyl hexamethyleneimine, isopropyl amine, methylamine, propyl amine, pyridine, quinoline, triethanolamine, triethylamine, trimethyl amine, vinyl amine, and 4-vinyl pyridine.

8. The composition (C) according to claim 1, wherein the organic acids (A2a) are selected from the group consisting of acetic acid, oxalic acid, trimethylglycine, citric acid, octanoic acid, nonanoic acid, dodecanoic acid, 2-furoic acid, maleic acid, pyruvic acid, lauric acid, glycolic acid, glutaric acid, malonic acid, succinic acid, terephthalic acid, oxalic acid, malic acid, fumaric acid, itaconic acid, acrylic acid, allyl acetic acid, butyric acid, crotonic acid, formic acid, D,L-lactic acid, 2-methyl acrylic acid, propionic acid, vinyl acetic acid, hydroxy pivalic acid, and phenyl acetic acid.

9. The composition (C) according to claim 1, wherein the organic alcohols (A2b) are selected from the group consisting of allyl alcohol, t-butyl cyclohexanol, xylitol, dextrose, 1,3-benzenediol, mannitol, benzyl alcohol, 2,3-butadiene-1-ol, 1,3-butanediol, 1,4-butanediol, t-butyl alcohol, 2-phenylethanol, thymol, 2-methoxy-4-methyl phenol, 2-sec-butyl phenol, 4-nitrophenol, 4-methyl cyclohexanol, butoxyethoxy propanol, 3-butoxy butanol, m-cresol, cyclohexanol, 2-cyclopentenyl alcohol, diacetone alcohol, 2-(diethyamino)ethanol, diethylene glycol, 2,6-dimethyl phenol, 3,4-dimethyl phenol, dipropylene glycol, dipropylene glycol methyl ether, ethanol, ethanolamine, 1-ethoxy-2-propanol, 2-ethyl-1-butanol, ethylene glycol, glycerol, hexylene glycol, 3-methyl-1-butanol, isobutyl alcohol, isooctyl alcohol, methanol, o-methoxyphenol, 3-methyl allyl alcohol, 2-methyl-1-butanol, 2-methyl-1-propanol, 2-methyl-2-butanol, 2-octanol, 1-pentanol, 2-pentanol, phenol, 2-phenoxy ethanol, 1-propanol, 2-propanol, propylene glycol, cuminol, triethanolamine, triethylene glycol, triethylene glycol monomethylether, 2-bromoallyl alcohol, 1,3-butanedol, 3-chloroallyl alcohol, 2-chloroallyl alcohol, 3-chloro-1-propanol, 4-chlorobnzyl alcohol, 2-chlorophenol, 1-decanol, 2-decanol, diisobutyl carbinol, 2-ethylhexanol, menthol, carvacrol, 2-ethyl phenol, o-methoxy, phenol, methyl isobutyl carbinol, and 4-isopropylbenzylmethanol.

10. The composition (C) according to claim 1, wherein the organic ester (A2c) is selected from the group consisting of butyl lactate, n-butyl salicylate, ethyl lactate, methyl salicylate, and methyl benzoate.

11. The composition (C) according claim 1, wherein the organic ether (A2d) is selected from the group consisting of triethylene glycol monomethylether, p-methoxyaniline, diethylene glycol hexylether, diethylene glycol monobutylether, diethylene glycol monoethylether, diethylene glycol monomethylether, diethylene glycol monopropylether, 1,2-dimethoxy benzene, 4-methoxy acetophenone, ethylene glycol monobenzyl ether, ethylene glycol mono-t-butyl ether, ethylene glycol monobutyl ether, ethylene glycol monoethyl ether, allyl ethylether, allyl methylether, butenyl methyl ether, butyl isopropenyl ether, di-n-butyl ether, diphenyl ether, di(2-methoxyethyl)ether, diallyl ether, dibenzyl ether, diethylene glycol butyl ether acetate, diethylene glycol divinyl ether, diethylene glycol dibutyl ether, diethylene glycol methyl t-butyl ether, diethylene glycol diethyl ether, diethylene glycol hexyl ether, diethylene glycol monobutyl ether, diethylene glycol monoethyl ether, diethylene glycol monoethyl ether acetate, di propylene glycol monomethyl ether acetate, ethylene glycol butyl ether acetate, ethylene glycol butyl ethyl ether, ethylene glycol di-t-butyl ether, ethylene glycol dibutyl ether, ethylene glycol butyl methyl ether, ethylene glycol diethyl ether, ethylene glycol methyl t-butyl ether, ethylene glycol mono-2-ethyl hexyl ether, ethylene glycol monoethyl ether acrylate, ethylene glycol monoisobutyl ether, anisole, 4-ethoxy acetophenone, 4-methoxy acetophenone, 4-methoxy benzonitrile, nonyl phenoxy ethanol, and bis-(m-phenoxyphenyl) ether.

12. A method of using a solvent system (A), the method comprising using the solvent system (A) for preparing an emulsifiable concentrate comprising at least one biocide (B), wherein the solvent system (A) comprises:
(A1) a first component selected from the group consisting of an organic keto compound (A1a), an organic amine (A1b) and a combination thereof; and
(A2) a second component selected from the group consisting of an organic acid (A2a), an alcohol (A2b), an ester (A2c), an ether (A2d), and a combination thereof;
wherein Hansen solubility parameters of the first component are in the ranges of δd 13-20 MPa^{1/2}, δp 0.2-23 MPa^{1/2} and δh 1-24 MPa^{1/2} and the Hansen solubility parameters of the second component (A2) are in the ranges of δd 13-25 MPa^{1/2}, δp 1-15 MPa^{1/2}, and δh 2-30 MPa^{1/2},
wherein the mole ratio of total amount of A1 to the total amount of A2 is in the range of from 1.0:5.0 to 5.0:1.0.

13. (canceled)

14. (canceled)

15. A method of preparing a composition (C) comprising the steps of:
i) providing a solvent system (A); and
ii) adding at least one biocide (B) to the solvent system (A) of step i. to obtain a mixture;
wherein the solvent system (A) comprises:
(A1) a first component selected from the group consisting of an organic keto compound (A1a), an organic amine (A1b) and a combination thereof; and
(A2) a second component selected from the group consisting of an organic acid (A2a), an alcohol (A2b), an ester (A2c), an ether (A2d), and a combination thereof,
wherein Hansen solubility parameters of the first component are in the ranges of δd 13-20 MPa^{1/2}, δp 0.2-23 MPa^{1/2} and δh 1-24 MPa^{1/2} and the Hansen solubility parameters of the second component (A2) are in the ranges of δd 13-25 MPa^{1/2}, δp 1-15 MPa^{1/2}, and δh 2-30 MPa,
wherein the mole ratio of total amount of A1 to the total amount of A2 is in the range of from 1.0:5.0 to 5.0:1.0.

16. (canceled)

17. (canceled)

18. An emulsion composition (E) comprising:
a. a composition (C) according to claim 1 in an amount in the range of from 0.1 to 20.0% by weight, based on the overall weight of the emulsion composition (E); and
b. water in an amount in the range of from 60.0 to 99.9% by weight based on the overall weight of the composition (E);
wherein the total amount of the composition (C) and water is in the range of from 61.1 to 100% by weight based on the overall weight of the emulsion composition (E).

19. A process for preparing an emulsion composition (E) comprising:
i) providing the composition (C) according to claim 1; and
ii) adding water to the composition (C) of step i. to obtain an emulsion composition (E).

20. (canceled)

21. A method of treating soil and plants the method comprising applying the emulsion composition (E) according to claim 18 to the soil or plants.

22. The composition (C) according to claim 1, wherein (A1) comprises an organic keto compound (A1a).

23. The composition (C) according to claim 1, wherein (A1) comprises an organic amine (A1b).

24. The method of use according to claim 12, wherein (A1) comprises an organic keto compound (A1a).

25. The method of use according to claim 12, wherein (A1) comprises an organic amine (A1b).

26. The method of preparing a composition (C) according to claim 15, wherein (A1) comprises an organic keto compound (A1a).

27. The method of preparing a composition (C) according to claim 15, wherein (A1) comprises an organic amine (A1b).
